(19) United States
(12) Patent Application Publication
(10) Pub. No.: US 2024/0403957 A1
(43) Pub. Date: Dec. 5, 2024

(54) MANAGING (NON-FUNGIBLE TOKEN) NFT COLLECTION SIZE WHILE MAINTAINING SCARCITY

(71) Applicant: Roberto Sebastian Boneta, Miami, FL (US)

(72) Inventor: Roberto Sebastian Boneta, Miami, FL (US)

(21) Appl. No.: 18/680,813

(22) Filed: May 31, 2024

Related U.S. Application Data
(60) Provisional application No. 63/505,230, filed on May 31, 2023.

(51) Int. Cl. G06Q 40/04; G06Q 40/06; H04L 9/00; H04L 9/06

(52) U.S. Cl. CPC G06Q 40/04; G06Q 40/06; G06Q 50/184; H04L 9/0643; H04L 9/50; G06Q 2220/00

(57) ABSTRACT

Disclosed are embodiments for fractionalized NFTs by displaying a non-fungible token (NFT); determining ownership of the NFT by a first user; identifying NFT splitting options based on one or more rules for the NFT; displaying NFT splitting options to the first user; receiving input from the first user to perform a particular splitting operation on the NFT; and executing a first smart contract, the execution of the first smart contract causing operations including: applying the one or more rules to the NFT to generate at least a first fractionalized NFT and a second fractionalized NFT; initiating recordation onto a blockchain of a removal of ownership by the first user of the NFT; and initiating recordation onto the blockchain of the ownership by the first user of the first fractionalized NFT and the second fractionalized NFT.

### BACKGROUND

NFT technology, short for non-fungible tokens, revolutionizes digital ownership by providing unique cryptographic tokens that cannot be replicated or interchanged. Through blockchain technology, NFTs authenticate digital assets, ranging from artwork and collectibles to virtual real estate, fostering a new era of ownership in the digital realm. NFTs enable creators to monetize their digital creations, while collectors can securely prove ownership and authenticity in a decentralized manner.

### CLAIM OF PRIORITY

This application claims the benefit of priority to U.S. Provisional Application Ser. No. 63/505,230, filed on May 31, 2023, which is incorporated herein by reference in its entirety.

### BRIEF SUMMARY

Some embodiments pertain to innovative systems and methodologies for various operations concerning non-fungible tokens (NFTs) and their associated multimedia or referenced files. These operations include minting, transferring, locking, unlocking, burning, un-burning, fractionalizing, redeeming, joining, reassembling, exchanging, associating, and/or conducting other transactions with NFTs. The disclosed systems and methods enable the management, expansion, and contraction of NFT-gated networks and collections through tokenization platforms and distributed ledgers such as blockchains, while addressing the scarcity of NFTs within these collections.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 depicts an exemplary ecosystem of the NFT system and NFT method, according to some examples.

FIG. 2 illustrates an example routine for splitting an NFT, according to some examples.

FIG. 3 illustrates an NFT splitting example, according to some examples.

FIG. 4 illustrates an example method for reassembling an NFT, according to some examples.

FIG. 5 illustrates an NFT reassembly process, according to some examples.

FIG. 6 illustrates an example method for NFT collection management, according to some examples.

FIG. 7 illustrates an architecture for affiliate features using NFT fractionalization, according to some examples.

### DETAILED DESCRIPTION

“Metcalfe's Law” delineates that the value of a network correlates with the square of its end nodes. For instance, a network with 8 nodes yields an inherent value of 64 (8×8=64), which increases to 81 (9×9=81) with the addition of one more node. However, in the context of NFT Networks and/or NFT Collections (collectively “NFT Collection” or plurally “NFT Collections”), governed by scarcity, the application of Metcalfe's Law may not hold true. The expansion of an NFT Collection by adding more NFTs (nodes) may potentially counteract theoretical increases in inherent value due to concurrent decreases in individual NFT value observed in marketplaces or trading platforms. Addressing this challenge is pivotal for NFT Collections seeking mass-market expansion. Moreover, the inherent non-fungibility of NFTs limits their liquidity as observed in marketplaces or trading platforms, also challenging their ability to expand into the mass market. Consequently, there exists a pressing demand for an innovative system and method capable of managing the size, scarcity, fungibility, and liquidity of NFT Collections effectively.

Although examples described herein are explained in terms of an NFT network, it is appreciated that an NFT-gated network can also be used. An NFT network includes a blockchain network or ecosystem where NFTs are created, bought, sold, and traded. The NFT network uses blockchain to mint, track, and transfer ownership of NFTs. The NFT network uses marketplaces to list, buy, and sell NFTs. The NFT network uses smart contracts (such as contracts that include programs written on the blockchain) that execute transactions automatically when certain conditions are met, ensuring unique ownership and provenance of the NFTs.

An NFT-gated network includes a community, platform, or service where access or certain privileges are controlled through the ownership of specific NFTs. The NFT-gated network can provide exclusive access where only users who own specific NFTs can access certain features, content, events, or areas within the network. The NFT-gated network can provide membership benefits, where holding a particular NFT might provide benefits such as voting rights, premium content, or special services. The NFT-gated network can perform verification using smart contracts to verify NFT ownership, ensuring only eligible users gain access to gated areas. The NFT-gated network can increase engagement and bestow incentives encouraging the community to engage in certain events and activities by offering unique rewards or experiences to NFT holders.

Systems and methods for managing NFT Collection size (by managing the amount of NFT nodes) while managing NFT scarcity, fungibility, and liquidity in a decentralized network are described. The following description presents a simplified summary in order to provide a basic understanding of some aspects described herein. This summary is not an extensive overview of the claimed subject matter. It is intended to neither identify key or critical components of the claimed subject matter nor delineate the scope thereof.

In some embodiments, a system for managing NFT Collection size while managing NFT scarcity, fungibility, and liquidity in a decentralized network may be provided. The system may include at least one processor configured with an “NFT Splitting Sub-System” and/or an “NFT Reassembly and/or Exchange Sub-System” and/or an “NFT Collection Management System”, as described infra. The system may include memory storing instructions defining one or more smart contract(s), which may be configured to be stored on a distributed ledger (e.g., blockchain). The smart contracts may be configured to receive one or more NFTs. The NFTs may comprise, include, or reference: NFT metadata and/or multimedia and/or other files (collectively hereinafter “NFT Data”). In some embodiments, the NFTs may represent ownership of a physical asset. In response to receiving the NFTs, the smart contracts may be configured to mint, transfer, receive, lock, unlock, burn, un-burn, split, reassemble, join, exchange, and/or otherwise transact with the NFTs, NFT Data, and/or other NFTs and/or NFT Data.

In some embodiments, a system using at least one processor may be configured to manage NFT Collection size through successive, tiered fractionalization that includes transferring, minting, locking, burning, and/or otherwise transacting with NFT(s) and/or NFT Data, creating scarcity, fungibility, and liquidity for some tiers of NFTs and/or NFT Data while increasing the total number of NFTs in an NFT Collection, when NFTs in all tiers are counted.

The fractionalization contains key innovative features that distinguish this feature from traditional systems, allowing the system to better address the problems described. Among these features, the fractionalization described herein is associative, destructive, tiered, and decentralized.

The system enables associative features in the sense that the NFTs are associated to NFT data, and both are fractionalized by the platform. The NFTs are inherently linked to their associated NFT data. The associative features, when the NFT is fractionalized, associates the data to each of the fractions accordingly. This tight coupling ensures that each fractional piece retains a share of the original NFT's metadata, provenance, and other embedded attributes (e.g., proportionally or unproportionally). This associative fractionalization maintains the integrity and contextual value of the original NFT in each fraction, ensuring that the fractional pieces are not just mere segments but carry the essence of characteristics of the whole.

The system enables destructive features in the sense that NFTs and associated NFT data are destructively divided by the platform into distinct pieces. While normal fractionalization would preserve the original NFT and any associated NFT data and simply issue new NFTs representing equal fractional ownership in an intact original, here the original NFT and its associated NFT data are effectively destroyed, and thus cannot be owned by anyone until all of the pieces are reassembled by the platform. In contrast, the system performs destructiveness by allowing the platform to drive scarcity while increasing size.

Unlike traditional fractionalization where the original NFT remains intact and new NFTs are issued to represent fractional ownership, the system destroys the original NFT and its associated data. The system divides the original NFT and its associated data into distinct pieces. The original NFT ceases to exist in its whole form during the fractionalization process. This destructiveness introduces a controlled scarcity, as the original NFT cannot be owned or utilized until reconstruction, adding a layer of strategic value and market dynamics.

Moreover, the fractionalization is tiered in the sense that it allows for successive fractionalization. With each successive tier of fractionalization, the NFT and associated NFT Data can become more granular or fungible, thus increasing liquidity and allowing for the effective management of these qualities. Tiered fractionalization also makes the fractionalization more decentralized in the sense that owners of successive fractions can independently choose to fractionalize or reassemble. Thus, the platform allows for decentralized, independent actors to contribute to the size, scarcity, fungibility, and liquidity of NFT Collections and NFT Data in real time in response to market forces.

The system supports tiered fractionalization allowing for successive layers of division. Each tier can further fractionalize an existing fraction, making the NFT and its associated data more granular. With each tier of fractionalization, the resulting fractions become more granular, allowing for a more detailed and nuanced representation of the original NFT. This increased granularity enhances the fungibility of the fractions, making them easier to trade and exchange in smaller denominations.

Moreover by allowing multiple levels of fractionalization, the platform significantly increases the liquidity of the NFTs. Smaller, more granular fractions can be more readily traded, lowering the entry barriers for new investors and collectors. Furthermore, each fractional owner can independently choose to further fractionalize their piece or reassemble it with others. This flexibility introduces a new layer of decentralization and autonomy, enabling market participants to respond in real-time to market forces and demand.

The system is designed to operate in a decentralized manner, allowing independent actors to fractionalize or reassemble NFTs and their associated data. This decentralization fosters a more resilient and adaptable ecosystem, where decisions are made collectively by the market participants rather than a centralized authority.

In some embodiments of the system the number of tiers, successive splitting or joining events, and/or multipliers applied are determined by one or more rule(s) stored in memory, on a network, one or more user or developer devices, nodes, and/or on a distributed ledger. In some embodiments the number of tiers, successive splitting or joining events, and/or multipliers applied cannot be changed. In some embodiments the number of tiers, successive splitting or joining events, and/or multipliers applied can be changed by an input. The system may be configured to receive inputs from users, developers, systems, and/or programs.

In some embodiments, a system using at least one processor may be configured to manage NFT Collection size through successive, tiered fractionalization that includes transferring, minting, locking, burning, and/or otherwise transacting with an NFT on a distributed ledger and also tiered, successive splitting of one or more multi-media or other files associated with an NFT, thereby creating scarcity, fungibility, and liquidity for some tiers of an NFT Collection while increasing the total number of NFTs in and/or gating an NFT-gated network and/or the total number of NFTs in an NFT Collection. In some embodiments the multimedia or other files are stored in memory, on a network, one or more user or developer devices, nodes, and/or on a distributed ledger. In some embodiments, the multimedia or other files can be split according to at least one splitting rule that may or may not be changed by an input. The system may be configured to receive inputs from users, developers, systems, or programs. In some embodiments, the splitting rule(s) cannot be changed.

In some embodiments, a system using at least one processor may be configured to gate access based on ownership of NFTs or numbers of NFTs within fractionalized tiers of NFT Collections. In some embodiments, the fractionalized tiers may be separate NFT collections. The system may be configured to receive inputs from users, developers, systems, and/or programs.

In some embodiments, a system using at least one processor may be configured to reassemble and/or exchange NFTs in an NFT Collection for other NFTs in an NFT Collection based on at least one rule. In some embodiments, one or more lower tier NFT(s) in an NFT Collection may be exchanged and/or reassembled into one or more higher tier NFT(s) in an NFT Collection. In some embodiments, one or more multimedia and/or other files associated with NFTs and/or referenced in NFT metadata may be joined to form one or more multimedia and/or other files associated with one or more NFTs in an NFT Collection. In some embodiments, the one or more multimedia and/or other files associated with and/or referenced in the metadata of lower tier NFTs in an NFT Collection may be joined into one or more multimedia and/or other files associated with and/or referenced in the metadata of higher tier NFTs in an NFT Collection. In some embodiments, the one or more rule(s) affecting the reassembly, joining, and/or exchange of NFTs and/or multimedia and/or other files may or may not be changed by an input. The system may be configured to receive inputs from users, developers, systems, and/or programs.

The systems and methodologies herein integrate distributed ledger technology, such as blockchain, alongside smart contracts and a tokenization platform. Distributed ledger technology serves as the cornerstone for the proliferation of cryptocurrencies and NFTs, characterized by a linked list of data blocks. Each block comprises encrypted data and a reference to the preceding block, potentially encompassing transactional data, executable digital contracts, and specific parties' asset-related information. The inclusion of a hash of the preceding block in each block ensures the integrity and immutability of the distributed ledger, preventing unauthorized modifications to prior blocks.

In numerous distributed ledger implementations, the management and expansion of the ledger are decentralized and spread across computer systems operated by various independent entities. These entities contribute computational power to the system, forming the infrastructure of the distributed ledger by storing ledger copies and executing algorithms to process transactions, create new blocks, and disseminate them across the network. Some ledger implementations compensate contributors with cryptocurrency fees for processing new blocks. Notably, distributed ledger security is reinforced by the challenge of modifying blocks once added to the ledger and accepted into the primary branch, notwithstanding the existence of temporary competing branches.

The evolution of distributed ledger technology has been marked by the integration of smart contracts. Smart contracts, executable computer programs developed by their creators, are compiled into blocks within a distributed ledger. Once deployed, users of the ledger can confidently execute these smart contracts, assured of their integrity against malicious tampering. Smart contracts, aptly named for their functionality, serve to formalize agreements among parties concerning the transfer and ownership of digital currency, NFTs, and diverse asset types, although they need not be limited to contractual arrangements.

A software developer initiates the creation of a smart contract by composing program code using scripting languages like JavaScript, Solidity, Rust, or others, or object coding languages such as Java, or machine coding languages like C or C++. Upon deployment of the smart contract into a distributed ledger, the program code undergoes processing into a block by a system contributor, akin to standard ledger transactions, often involving payment of a fee to the compiling contributor. The deployment process may encompass compiling the program code into byte code, object code, binary code, or another executable form. Following successful deployment, the smart contract receives an address within the distributed ledger, facilitating access to and execution of its functionality. Typically, an application binary interface (ABI), akin to an application programming interface, is furnished to users or software interfacing with the contract (e.g., wallet applications), enabling interaction with its functions. The ABI delincates the functions and methods inherent in the smart contract, ensuring accessible utilization by users or their software.

Once a contract/program is deployed into the distributed ledger, it becomes accessible to anyone possessing its ledger address. The execution of the contract, or a segment thereof, typically does not involve fees unless ledger updates are necessitated by the contract's execution. Properly implemented contracts/programs can accommodate multiple users concurrently, enabling them to oversee their respective agreements or transactions seamlessly.

In certain embodiments, a smart contract/program may comprise multiple steps executed or fulfilled by diverse contract parties. Smart contracts are ideally suited for agreements involving digital assets or those entirely executed through programmatic interactions among contracting parties, the distributed ledger, digital assets, and internet-connected resources. For instance, smart contracts can autonomously transfer control and ownership of digital assets like digital currencies, NFTs, or tokens representing real-world property interests.

The disclosed embodiments pertain to systems and techniques for creating, transferring, securing, subdividing, redeeming, linking, and/or conducting various transactions involving NFTs and associated NFT Data via a tokenization platform. These systems, techniques, and/or platform may facilitate the administration, augmentation, and/or reduction of NFT Collections while addressing the scarcity, fungibility, and liquidity of NFTs and NFT Data through distributed ledgers.

### Overall System Architecture

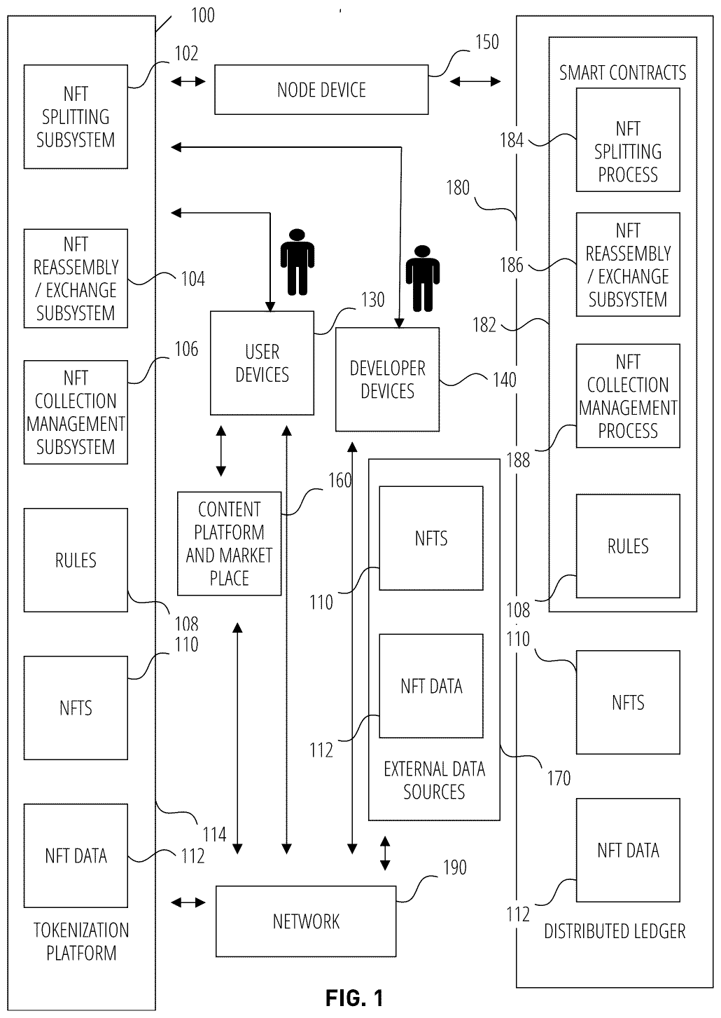

FIG. 1 depicts an exemplary ecosystem of the NFT system and NFT method, according to some examples. As illustrated in FIG. 1, the NFT system and NFT method comprise: a Tokenization Platform 100 (comprising an NFT Splitting Sub-System 102, an NFT Reassembly and/or Exchange Sub-System 104, an NFT Collection Management Sub-System 106, Rules 108, NFT(s) 110, and/or NFT Data 112); User Device(s) 130; Developer Device(s) 140; Node Devices 150; Content Platforms and Marketplaces 160; External Data Sources 170 (comprising NFT(s) 110 and NFT Data 112); Distributed Ledger(s) 180; and a Network 190.

The User Device(s) 130, Developer Device(s) 140, Content Platforms & Marketplaces 160, External Data Sources 170, Node Device(s) 150, and Tokenization Platform 100 can establish communication via a network 190.

In certain embodiments, the Tokenization Platform 100 oversees one or more Distributed Ledger(s) 180. The tokenization platform includes a software or system component designed to tokenize assets, such as NFTs (Non-Fungible Tokens), where users can create, manage, and trade tokens representing various assets. A distributed ledger can include a decentralized database that records transactions across multiple locations or participants in a network. In the context of NFTs, the distributed ledger could be a blockchain or a similar decentralized ledger technology where ownership and transaction records of NFTs are stored. The Tokenization Platform 100 has authority or control over the management, operation, and in some cases, the security of the Distributed Ledger(s) 180. The platform may handle tasks such as validating transactions, updating ledger records, and ensuring compliance with rules and protocols governing the ledger.

Content Platforms & Marketplaces 160 may, in certain embodiments, facilitate user interactions with content and transactions involving NFTs 110 and/or NFT Data 112. The Content Platforms & Marketplaces 160 can include platforms or online marketplaces where users can interact with products, services, and digital content, such as artwork, music, videos, and other creative works. These platforms may enable users to buy, sell, and trade NFTs. The Content Platforms & Marketplaces 160 provide a space for users to engage with products, services, digital content and conduct transactions related to NFTs. Users can explore, view, purchase, and sell NFTs, as well as interact with associated data like metadata or descriptions.

The Tokenization Platform 100, in some instances, receives data (including NFT Data 112) from one or more External Data Sources 170, which can denote any system or device supplying data to the Tokenization Platform 100. These sources could be other systems, databases, or devices that provide data relevant to NFTs, such as metadata, ownership records, or transaction histories.

External Data Sources 170 may encompass User Device(s) 130 or Developer Device(s) 140 in certain embodiments. Furthermore, the Tokenization Platform 100 interfaces with various User Device(s) 130 and Developer Device(s) 140, encompassing any computing device enabling access to the Tokenization Platform 100 by users (e.g., consumers, merchants, manufacturers, providers, etc.). Examples include smartphones, tablets, laptops, personal computers, smart TVs, gaming consoles, wearable devices, augmented reality interfaces, and similar devices. User Device(s) 130 may access the Tokenization Platform 100 through a website, web application, decentralized application (“dApp”), native application, etc. The system may, in certain embodiments, offer a graphical user interface for User Device(s) 130 and Developer Device(s) 140.

In certain embodiments, Distributed Ledger(s) 180 may encompass Smart Contracts 182 and/or Rules 108 aligned with the NFT method, inclusive of an NFT Splitting Process 184, NFT Reassembly and/or Exchange Process 186, and/or NFT Collection Management Process 188. The Tokenization Platform 100, in some embodiments, is configured to shard Distributed Ledger 180, resulting in side chains branching from the main chain. The Distributed Ledger(s) 180 can include decentralized databases that store records of transactions across a network of computers. In the context of NFTs (Non-Fungible Tokens), distributed ledgers are used to record ownership, transfers, and other metadata related to NFTs.

Smart contracts include self-executing contracts with the terms of the agreement directly written into code and onto the blockchain ledger. The smart contracts may be designed to facilitate various operations related to NFTs, such as splitting, reassembly, exchange, or collection management. Rules 108 may include protocols or guidelines governing the behavior and interactions within the distributed ledger system.

The NFT Splitting Process 184, NFT Reassembly and/or Exchange Process 186, and/or NFT Collection Management Process 188 are procedures or operations within the distributed ledger system designed to handle specific tasks related to NFTs. The splitting process may include dividing an NFT into smaller parts as partial NFTs, reassembly and exchange processes may include combining or swapping NFTs, and collection management may include organizing and administering groups of NFTs.

Sharding includes partitioning data across multiple servers or nodes. In this case, the Tokenization Platform 100 is set up to segment the Distributed Ledger 180 into smaller side chains, which are separate chains of transactions that branch off from the main ledger. This can help improve scalability and efficiency in managing NFT-related transactions and data.

Within these embodiments, a side chain may contain virtual representations of NFTs 110 and/or NFT Data 112 categorized according to specific classes. Side chains include secondary blockchains that operate independently but are connected to the main blockchain. They include offloading some of the transactional burden from the main blockchain and can be customized to serve specific purposes, as further described herein. Within side chains, virtual representations of NFTs 110 and/or NFT Data 112 can be stored. These representations could include metadata, descriptions, and other information associated with the NFTs. The NFTs stored within side chains can be categorized according to specific classes. This categorization helps organize and manage NFTs based on their characteristics, properties, or attributes.

Such side chains may store tokens corresponding to NFTs 110 and/or NFT Data 112 within the designated class, alongside ownership records reflecting current and past ownership. Side chains store tokens corresponding to NFTs within the designated class. These tokens act as digital representations of the NFTs and facilitate transactions and ownership transfers.

Alongside storing tokens, side chains also maintain ownership records reflecting current and past ownership of the NFTs within the designated class. These records track the history of ownership transfers and provide a transparent view of ownership.

Each instance of token ownership transfer prompts amendments to the implicated side chain, updating the token's ownership details. Whenever there is a transfer of token ownership, the ownership records within the side chain are updated. Each instance of token ownership transfer triggers amendments to the side chain, ensuring that ownership details are accurate and up-to-date.

Additionally, side chains in certain embodiments may store multimedia and/or other files linked to virtual representations, such as videos, photographs, audio clips, and assorted files. In certain embodiments, side chains may store multimedia and other files linked to virtual representations of NFTs. These files could include videos, photographs, audio clips, and other assorted files associated with the NFTs. Storing multimedia and files alongside NFTs enriches the user experience and provides additional context and information about the NFTs.

During operation, users or developers can direct the Tokenization Platform 100 to perform actions such as minting, transferring, locking, unlocking, burning, un-burning, fractionalizing, redeeming, joining, reassembling, exchanging, associating, and/or conducting various transactions involving NFTs 110 and/or NFT Data 112. In certain embodiments, some or all of these transactions may be transparent to users, focusing on the splitting and/or reassembly of NFT Data 112 associated with NFTs 110. In other embodiments, some or all of these transactions may be opaque to users. The NFT system and method described herein enable the management, expansion, and/or contraction of NFT Collections utilizing Distributed Ledgers 180, while addressing the scarcity, fungibility, and liquidity of NFTs 110 and/or NFT Data 112 within NFT Collections.

Users or developers have the capability to instruct the Tokenization Platform 100 to perform various actions related to NFTs (Non-Fungible Tokens). These actions include:
Minting: Creating new NFTs.
Transferring: Sending NFTs from one party to another.
Locking: Temporarily restricting access to NFTs.
Unlocking: Removing restrictions on access to NFTs.
Burning: Destroying NFTs.
Un-burning: Restoring NFTs that were previously destroyed.
Fractionalizing: Dividing NFTs into smaller parts as partial NFTs.
Redeeming: Exchanging NFTs for other assets or benefits.
Joining: Combining multiple NFTs into one.
Reassembling: Restoring NFTs from fragmented parts.
Exchanging: Trading NFTs for other assets or NFTs.
Associating: Linking NFTs with other assets or data.
These actions can involve NFTs (110) and associated NFT data (112).

In certain cases, the transactions performed on the Tokenization Platform 100 may be transparent to users (e.g., written onto the blockchain ledger). In other cases, only certain transactions are transparent, such as splitting or reassembly of NFT data (112) associated with NFTs (110). In some cases, users may not be aware of the specific actions taken by the platform, but they still benefit from the outcomes, such as the management or reconfiguration of NFTs.

Node devices 150 in the context of NFTs and blockchain can include individual computers or servers that participate in the network by maintaining a copy of the blockchain and validating transactions. These nodes play a critical role in the decentralized nature of blockchain networks, as they collaborate to reach consensus on the validity of transactions and ensure the integrity of the distributed ledger. Node devices store a complete history of transactions, verify new transactions, and propagate them across the network.

These node devices contribute to the security and reliability of the blockchain by enforcing consensus rules and preventing double-spending. In the realm of NFTs, node devices enable the creation, transfer, and verification of non-fungible tokens, ensuring the authenticity and ownership of digital assets represented by NFTs within the blockchain ecosystem.

In some cases, the NFT splitting sub-system 102, the NFT reassembly and/or exchange sub-system 104, and the NFT collection management sub-system 106 have one or more similar system architectural designs. For example, all three sub-systems can include NFTs 110, NFT data, Rules 108, a memory, a processor, a processor configuration, and/or the like. In some cases, at least two of the sub-systems share certain software and/or hardware. For example, the same NFT database can be referenced by all three sub-systems.

For the sake of simplicity, one of the sub-systems will be described. However it is appreciated that features for one of the sub-systems can apply to a different subsystem.

The NFT Splitting Sub-System 102 can be the gateway to which NFT(s) 110 and/or NFT Data 112 is presented and authenticated for transacting with a User Device(s) 130, after which NFT Splitting Sub-System 102 can execute one or more of the Rules 108 in the Tokenization Platform 100. The example NFT Splitting Sub-System 102 includes a Memory, a Processor, and a Communications Subsystem. A communication connection is implemented between the Memory, Processor, and Communication Subsystem, for example using a bus and/or connecting to a Network 190. The Communications Subsystem implements wired and/or wireless communication between the NFT Splitting Sub-System 102 and the Network 190.

The Processor is configured to perform, when a program or Smart Contract 182 stored in Memory is executed by the Processor, steps of the NFT method and/or system as further described herein. The Processor may also run a program or Smart Contract 182 based on Program Configurations. In some examples, NFT Splitting Sub-System 102 may be smartphones, tablet computer devices, laptop computers, personal computers, smart televisions, gaming consoles, wearable computers, augmented reality interfaces, and the like. In some examples, the NFT Splitting Sub-System 102 can be the Processor that executes the described software and functions of the NFT Splitting Sub-System 102. The Processor can be a general central processing unit (CPU), a microprocessor, an application specific integrated circuit (ASIC), graphics processing unit (GPU), or one or more integrated circuits.

The Memory can be a read-only memory, a static storage device, a dynamic storage device, or a random access memory. The Memory may store a program. The Memory may be a non-transitory memory. The Memory can be external or removable and some examples. In an example, the Memory includes a Tokenization Platform 100. The Tokenization Platform 100 can store information associated with Distributed Ledgers 180 such as private keys, public keys, pass codes, etc.

In examples, the NFT Splitting Sub-System 102 includes Smart Contracts 182 and/or Processor Configurations. The Smart Contracts 182 and/or Processor Configurations include performing transactions over the Distributed Ledger(s) 180. The Smart Contracts 182 and/or Processor Configurations also manage pass codes in order to transact with NFT(s) 110 and NFT Data 112. The Smart Contracts 182 and/or Processor Configurations also manage access. Access may be conditioned upon and/or gated by NFT(s) 110 and/or NFT Data 112. The NFT Splitting Sub-System 102 can access and transact with NFT(s) 110 and NFT Data 112 by using private keys in the form of transactions on the Distributed Ledger 180. The Tokenization Platform 100 includes the distributed ledger addresses of NFTs 110 and NFT Data 112 on the Distributed Ledger(s) 180. The NFT Splitting Sub-System 102 can include user interface devices for user input and user output, not shown.

It should be noted that a person skilled in the art should understand that the NFT Splitting Sub-System 102 may further include other components that are necessary for implementing execution of the NFT system and/or the NFT method. In addition, based on specific needs a person skilled in the art should understand that the NFT Splitting Sub-System 102 may further include hardware components that implement other additional functions. In addition, a person skilled in the art should understand that the NFT Splitting Sub-System 102 may include only a component required for implementing the embodiments, without a need to include all the components shown in FIG. 1.

In some cases, the Memory includes a Digital Wallet. The Digital Wallet stores one or more wallet addresses of the User Device(s) 130. The Digital Wallet can also store additional information associated with Distributed Ledger 180 transactions, Distributed Ledgers 180, and/or the Tokenization Platform 100 such as private keys, public keys, pass codes, etc.

In examples, the User Device(s) 130 includes a Digital Wallet, Decentralized Applications (“dApps”), Smart Contracts 182, and/or Processor Configurations. The Digital Wallet includes performing transactions over the Distributed Ledger 180 and communicating with the Node Devices 150 and Tokenization Platform 100. The Digital Wallet also manages user pass codes in order to access the wallet, NFT(s) 110, and NFT Data 112. The Digital Wallet also manages user access to dApps, Smart Contracts 182, and Processor Configurations. Access may be conditioned upon and/or gated by NFT(s) 110 and/or NFT Data 112. The Digital Wallet 130 includes wallet private keys and wallet public keys. Each wallet private key corresponding to a wallet public key. The wallet private keys are kept secret with the User Device(s) 130. The User Device(s) 130 can access and transact with NFT(s) 110 and NFT Data 112 by using the wallet private key in the form of transactions on the Distributed Ledger 180. The Digital Wallet includes the distributed ledger addresses of the NFTs 110 and NFT Data 112 on the Distributed Ledger 180 that are owned by the User Device(s) 130. The User Device(s) 130 can have other user password and security features to protect the wallet private keys, which are understood in the art and not described here. The User Device(s) 130 can include user interface devices for user input and user output, not shown.

In some examples, the Developer Device(s) 140 includes a Digital Wallet, Decentralized Applications (“dApps”), Smart Contracts 182, and/or Processor Configurations. The Digital Wallet includes performing transactions over the Distributed Ledger 180 and communicating with the Node Devices 150 and Tokenization Platform 100. The Digital Wallet also manages user pass codes in order to access the wallet, NFT(s) 110, and NFT Data 112. The Digital Wallet also manages user access to dApps, Smart Contracts 182, and Processor Configurations. Access may be conditioned upon and/or gated by NFT(s) 110 and/or NFT Data 112. The Digital Wallet 130 includes wallet private keys and wallet public keys. Each wallet private key corresponding to a wallet public key. The wallet private keys are kept secret with the Developer Device(s) 140. The Developer Device(s) 140 can access and transact with NFT(s) 110 and NFT Data 112 by using the wallet private key in the form of transactions on the Distributed Ledger 180. The Digital Wallet includes the distributed ledger addresses of the NFTs 110 and NFT Data 112 on the Distributed Ledger 180 that are owned by the Developer Device(s) 140. The Developer Device(s) 140 can have other user password and security features to protect the wallet private keys, which are understood in the art and not described here. The Developer Device(s) 140 can include user interface devices for user input and user output, not shown.

In some examples, the Node Device(s) 150 includes a Tokenization Platform 100, Decentralized Applications (“dApps”), Smart Contracts 182, and/or Processor Configurations. The Tokenization Platform 100 includes performing transactions over the Distributed Ledger(s) 180. The Tokenization Platform 100 also manages pass codes in order to transact with NFT(s) 110 and NFT Data 112. The Tokenization Platform 100 also manages access to dApps, Smart Contracts 182, and Processor Configurations. Access may be conditioned upon and/or gated by NFT(s) 110 and/or NFT Data 112. The Node Device(s) 150 can access and transact with NFT(s) 110 and NFT Data 112 by using private keys in the form of transactions on the Distributed Ledger 180. The Tokenization Platform 100 includes the distributed ledger addresses of NFTs 110 and NFT Data 112 on the Distributed Ledger(s) 180. The Node Device(s) 150 can include user interface devices for user input and user output, not shown.

### Nft Splitting Sub-System Processor Configurations

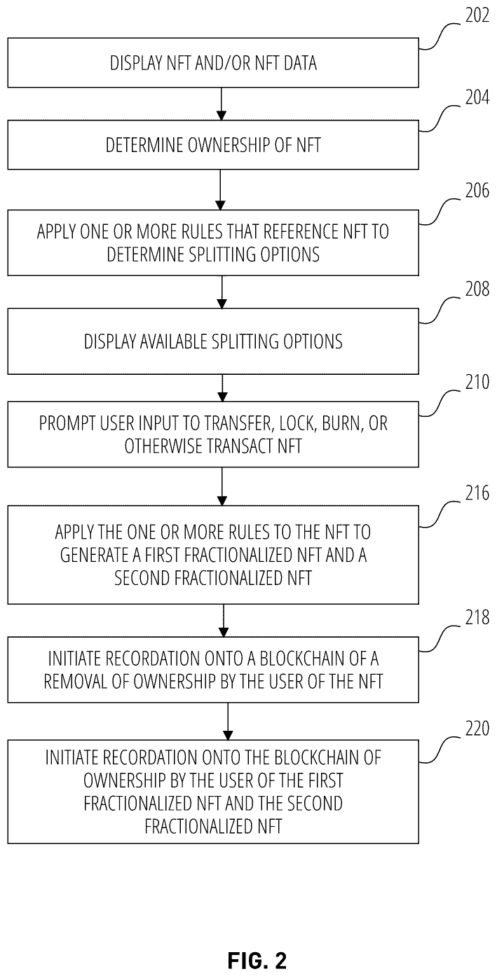

FIG. 2 illustrates an example method for splitting an NFT, according to some examples. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

At block 202, the NFT system displays an non-fungible token (NFT) or NFT data. A user using a User Device 130 wishes to split an NFT 110 and/or NFT Data 112 in an NFT Collection on a Distributed Ledger 180. The NFT system can identify an NFT, such as an NFT that the user has selected or that a user's wallet is connected to for display.

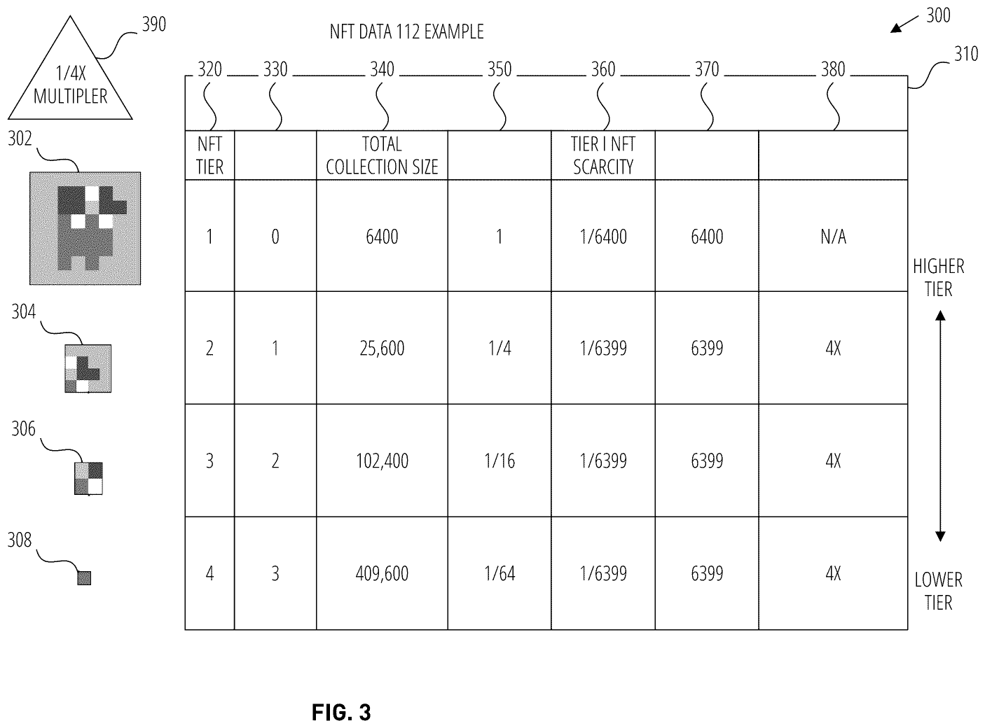

FIG. 3 illustrates an NFT splitting example, according to some examples. An NFT 302 can be identified by the NFT system. The NFT system can display the NFT, which in FIG. 3, is an 8×8 pixel NFT graphic, a multimedia image file in an NFT Collection.

The NFT system can display the NFT by rendering its associated metadata and digital assets in a user-friendly interface. When a user interacts with an NFT within the system, the platform retrieves relevant information such as the NFT's title, description, creator details, and any attached multimedia files like images, videos, or audio clips.

This metadata, along with the digital asset itself, is then presented to the user through the platform's user interface, which can include a website, mobile application, or specialized NFT marketplace. The system may employ various visualization techniques to showcase the NFT, including thumbnail images, previews, or immersive displays depending on the nature of the digital asset.

Additionally, the NFT system may allow users to explore additional details about the NFT, such as its ownership history, transaction records, and associated smart contract functionalities.

At block 204, the NFT system determines ownership of the NFT. The determination of ownership of an NFT within an NFT system primarily relies on the data stored within the underlying blockchain or distributed ledger technology. Each NFT can be associated with a unique token ID that distinguishes it from other tokens within the system.

The blockchain maintains a transparent and immutable record of ownership transfers for each NFT. This ledger records every transaction involving the NFT, including the address of the sender and recipient, the amount transferred, and the timestamp.

Ownership of an NFT is linked to a user's digital wallet, which is secured by public key cryptography. Users possess a private key that allows them to sign transactions and prove ownership of their assets. When a user acquires an NFT, a transfer transaction is recorded on the blockchain, updating the ownership record to reflect the new owner's wallet address.

Smart contracts govern the behavior of NFTs and enforce rules regarding ownership transfers. These contracts may include conditions for transferring ownership, royalties, and licensing agreements embedded within the NFT.

In addition to on-chain data, NFT systems may store metadata and off-chain content associated with each NFT. This metadata can include details about the NFT's creator, description, and provenance, which may inform ownership claims.

By analyzing the transaction history and verifying digital signatures, the NFT system can accurately determine the current owner of an NFT. Users can query the blockchain to retrieve ownership information and verify the authenticity of their NFT holdings.

At block 206, the NFT system identifies NFT splitting options based on one or more rules for the NFT. The NFT system applies one or more Smart Contract(s) 182 and/or Rules 108 to determine and display splitting options available for the NFT 110 and/or NFT Data 112. The Smart Contracts 182 and/or Rules 108 reference the NFT 110 and no other NFT to determine the splitting options available.

At block 208, the NFT system displays NFT splitting options to the user. The NFT system can present users with functionalities or features that enable the division of a single NFT into multiple smaller units, each representing a fraction of the original asset.

The NFT system provides a user-friendly interface where owners of NFTs can explore and access splitting options. This interface may include buttons, menus, or dropdowns that allow users to initiate the splitting process.

Users may be presented with various parameters and options for splitting their NFTs. These parameters could include the number of units to split the NFT into, the percentage of ownership each unit represents, any associated fees or royalties, and/or the like.

Users can split their NFTs into multiple fractional shares, allowing multiple individuals to own a portion of the asset. Each fractional share represents a percentage of the total ownership rights associated with the NFT. The NFT system can create or apply smart contracts that tokenize the NFT and issue fractional shares to multiple addresses. These smart contracts define the ownership structure and specify the rights and privileges associated with each fractional share. Fractional shares can be traded and transferred on decentralized exchanges or NFT marketplaces, enabling investors to diversify their portfolios and participate in high-value assets without requiring full ownership. Smart contract functionality ensures that fractional owners receive proportional benefits, such as royalties or voting rights, in accordance with their ownership stake. This democratization of ownership expands access to exclusive assets and promotes broader participation in the NFT ecosystem, fostering a more inclusive and decentralized digital economy.

NFTs can be split into multiple tokens, each representing a distinct aspect or component of the original asset. For example, an artwork NFT could be split into separate tokens representing different layers, colors, or elements of the artwork.

The NFT system can analyze the composition of the original asset and identify its constituent elements. Smart contracts are then deployed to tokenize each individual component, assigning unique identifiers and metadata to ensure their integrity and authenticity. These tokens can be traded, exchanged, or sold independently, allowing collectors to acquire specific elements of the artwork that resonate with their preferences or interests. Additionally, tokenization facilitates transparent provenance tracking, enabling users to trace the history and ownership of each component back to the original NFT. This granular approach to splitting NFTs enhances market liquidity and facilitates more nuanced forms of ownership and investment in digital assets.

NFT bundles or collections can be divided into individual tokens, allowing users to trade and transfer specific items within the bundle independently. This enables more granular control over the assets contained within the bundle. The NFT system can create a structure within the smart contract that allows for the segmentation of the bundle into individual components or assets. Each asset is then assigned a unique identifier and metadata, ensuring its distinguishability and authenticity within the collection. Smart contracts govern the ownership and transfer of these individual tokens, providing a secure and transparent mechanism for users to interact with the bundled assets. Users can selectively trade or transfer specific items from the bundle, enhancing liquidity and facilitating more targeted transactions within the NFT ecosystem. Additionally, the ability to divide NFT bundles into individual tokens enables creators and collectors to curate customized collections tailored to specific preferences or themes, further enriching the diversity and utility of digital asset portfolios.

NFT owners can split their assets while retaining ownership of a portion and distributing royalties to other participants. This model enables collaborative ownership and revenue-sharing arrangements for NFTs. The NFT system can develop or apply smart contracts that govern the ownership structure and royalty distribution mechanisms. Smart contracts define the terms and conditions of the revenue-sharing agreement, including the percentage of royalties allocated to each participant and the conditions under which royalties are disbursed. Ownership of the NFT is tokenized, with fractional shares representing each participant's stake in the asset. When the NFT generates revenue, such as through resale or licensing, smart contracts automatically calculate and distribute royalties to the respective stakeholders based on their ownership percentage. Blockchain technology ensures transparency and immutability, providing participants with visibility into revenue streams and ensuring accurate and timely distribution of royalties. This collaborative ownership model fosters community engagement and incentivizes creators and investors to collaborate on NFT projects, driving innovation and value creation within the digital asset ecosystem.

NFTs can be split based on time intervals or usage periods. For example, an NFT representing access to digital content or services could be divided into time-limited tokens, each granting access for a specific duration. In other cases, the NFT can be split based on time intervals of the media file, such as a video that is split into multiple segments.

NFTs can be split based on geographic regions or locations. This splitting option enables users to tokenize assets tied to specific regions, such as real estate properties or event tickets, allowing for localized ownership and trading.

NFTs can be split based on different functionalities or features embedded within the asset. For instance, an NFT representing a video game character could be divided into tokens representing distinct abilities or attributes of the character.

NFTs can be split into interoperable tokens that can be used across multiple platforms or ecosystems. This enables seamless integration and transferability of assets between different NFT marketplaces and applications.

NFTs can be split based on predefined conditions or triggers specified by smart contracts. For example, an NFT representing a digital collectible could be divided into tokens that unlock additional features or content based on specific conditions being met.

NFTs can be split dynamically based on fluctuating market conditions or user preferences. This option allows users to adjust the division of their assets in real-time to optimize trading strategies or investment portfolios.

NFTs can be split into tokens that represent voting rights or governance stakes within decentralized autonomous organizations (DAOs) or community-driven platforms. This enables collaborative decision-making and collective ownership of NFT-based projects.

NFTs can be split in a customizable manner, allowing users to define their own parameters for dividing the asset. This could include specifying the criteria for splitting, such as percentage ownership distribution or tokenization based on specific attributes of the asset.

NFTs can be split sequentially over time, where the splitting process occurs in stages or increments. This approach allows for gradual distribution of ownership or access rights, providing users with flexibility in managing their assets over time.

NFTs can be split using a combination of different splitting methods, allowing users to tailor the division process to their unique requirements. For example, a hybrid splitting approach could involve combining time-based and functionality-based splitting to create tokens with specific usage rights and durations.

NFTs can be split to enable fractional ownership for investment purposes. This allows multiple investors to collectively own a portion of high-value assets, such as rare artwork or collectibles, while benefiting from potential appreciation in value over time.

NFTs can be split in a permissioned manner, where access to the split tokens is restricted to specific individuals or groups. This option provides enhanced security and control over the ownership and distribution of NFT assets, particularly in sensitive or regulated environments.

NFTs can be split into divisible tokens that can be further subdivided into smaller units. This granularity in splitting enables finer control over asset ownership and facilitates microtransactions or fractional trading of NFTs.

NFTs can be split based on dynamic pricing mechanisms, where the value of the split tokens adjusts in real-time based on market demand and other factors. This approach enables efficient pricing and trading of NFT assets in response to changing market conditions.

NFTs can be split into a number per split and/or into different tiers. The NFT system splits an NFT into different tiers of fractions, that involve breaking down the original NFT into progressively smaller units or fractions, each representing a different level or tier of ownership.

In the example of FIG. 3, the original NFT 302 is split into 4 fractional NFTs at tier one, such as tier one NFT 304, composed of 16 pixels, a 4×4 pixel image. Each of these 4 fractional NFTs at tier one represents ¼th ownership of the original NFT. The NFT system identifies three splitting events, each with a splitting event multiplier of 4×. In some cases, the splitting event multiplier is the same from tier to tier. In other cases, the splitting event multiplier is different from tier to tier (e.g., 4× from tier one to tier two, 8× from tier two to tier three).

Each of the 4 fractional NFTs at tier one can be further split into 4 fractional NFTs at tier two. This results in a total of 16 fractional NFTs at tier two, such as tier two NFT 306, composed of four pixels, a 2×2 pixel image. Each fractional NFT at tier two represents 1/16th ownership of the original NFT. These 16 fractional NFTs at tier two collectively represent the original NFT that was split at tier one.

As noted herein, the NFTs could include videos, photographs, audio clips, 3D assets, programs, other multimedia files, data, or other files. The features corresponding to the fractional NFTs described herein can be applied to a wide range of multimedia files, such as videos, photographs, audio clips, 3D assets, programs, and other types of data. Fractionalizing these assets makes them more accessible and can enhance their marketability, liquidity, and utility in various contexts.

For instance, consider a high-value video clip or a photograph. By creating an NFT that represents this media and then fractionalizing it by destroying the original NFT and its corresponding metadata, multiple users can own a share of the media and its metadata. Each fraction can be bought, sold, or traded independently, allowing for broader participation and investment. This process involves smart contracts on blockchain platforms, ensuring secure and transparent ownership records. The owners of the fractions can also benefit from any revenue generated by the media, such as licensing fees or advertising revenue, distributed according to their ownership percentage.

Similarly, 3D assets and programs can be fractionalized to enhance their utility and value. For example, a complex 3D model used in virtual environments or games can be owned by multiple parties, each having a stake in its usage and any revenue it generates. Programs or software can be fractionalized to allow shared ownership and access, where each owner might receive a portion of the profits from sales or subscriptions. This approach democratizes access to high-value digital assets, providing opportunities for collaboration and co-ownership that were previously limited to individual or institutional ownership.

Photographs can be fractionalized by dividing the ownership rather than the physical file. For instance, a high-resolution photograph can be represented by an NFT, and fractional NFTs can be created to represent shares in the ownership of this NFT. Each fraction represents a percentage of the ownership, and owners can buy or sell their shares. Another method is to divide the photograph into a grid of smaller sections, where each section is represented by a fraction. This approach can add an interactive element, where owners might only have access to or display rights for their specific section of the photograph.

Photographs can be fractionalized by dividing the ownership rather than the physical file. For instance, a high-resolution photograph can be represented by an NFT, and fractional NFTs can be created to represent shares in the ownership of this NFT. Each fraction represents a percentage of the ownership, and owners can buy or sell their shares. Another method is to divide the photograph into a grid of smaller sections, where each section is represented by a fraction. This approach can add an interactive element, where owners might only have access to or display rights for their specific section of the photograph.

3D assets can be fractionalized by segmenting the asset into smaller components or by dividing the ownership of the entire asset. For example, a complex 3D model could be split into different parts (e.g., head, body, limbs) with each part represented by a fractional NFT. Owners can trade their specific components or hold shares in the overall 3D asset. This approach is beneficial in virtual environments or games, where different users can own and interact with different parts of a 3D object.

Data can be fractionalized in several ways, depending on its type and usage. For structured data, such as databases, fractionalization can be achieved by dividing the dataset into smaller subsets, each represented by a fractional NFT. Each subset can be independently owned and traded, providing access to specific parts of the data. For unstructured data, like large text documents or datasets, fractionalization can involve segmenting the data into logical parts (e.g., chapters of a book, sections of a report). Owners of these fractions could have access rights, usage rights, or revenue shares from any monetization of the data.

Overall, fractionalizing NFTs for multimedia files and data can revolutionize the way digital assets are owned and monetized. It enables greater participation, liquidity, and utility while ensuring transparent and secure ownership through blockchain technology. This approach can lead to new economic models and opportunities, fostering innovation and collaboration in the digital asset space.

Each of the 16 fractional NFTs at tier two can be split into 4 fractional NFTs at tier three. This yields a total of 64 fractional NFTs at tier three. Each fractional NFT at tier three represents 1/64th ownership of the original NFT. These 64 fractional NFTs at tier three collectively represent the original NFT that was split at tier two.

In an example of FIG. 3, the NFT system can configure an NFT Collection so that, at Splitting Event 1, a user owning an NFT 110 in the Collection could split the NFT 110 and/or NFT Data 112 into 4×¼ fractions. At Splitting Event 2, a user owning a ¼ fraction of an NFT 110 in the NFT Collection, could split the NFT 110 and/or NFT Data 112 into 4× 1/16 fractions. At Splitting Event 3, a user owning a 1/16 fraction of an NFT 110 in the NFT Collection, could split the NFT 110 and/or NFT Data 112 into 4× 1/64 fractions.

In an example, as the Total Collection Size 340 increases after successive Splitting Events 330, the Tier I NFT Scarcity 360 of the NFT 110 either increases or remains the same. In an example, a developer could use the NFT Collection Management Sub-System 106 and/or NFT Collection Management Process 188 to reconfigure variables in the Smart Contracts 182 and/or Rules 108 governing or affecting the expansion of the NFT Collection. In an example, the variables include, but are not limited to, the number of Splitting Events 330 and/or the Splitting Event Multiplier 380. In an example, the NFT Data 112 includes but is not limited to an image multimedia file. In other examples, the NFT Data may include, but not be limited to, videos, photographs, audio clips, 3D assets, programs, other multimedia files, other files, and/or tokenized interests in non-digital assets and/or property.

With each splitting event (e.g., 1 splitting event going from tier one to tier two, the total collection size increases. For example, the original NFT can be a part of a collection size of 6400 NFTs. After splitting the entire collection, the NFT collection size increases to 25,600, which is four times the original collection size. However, the NFT scarcity does not change because the potential total number of full NFTs has not changed. Instead, individual NFTs have been fractionalized into smaller parts. In a sense, scarcity may even be increased by this expansion in total collection size because each time a full NFT is split, there is one less full NFT.

In some cases, the splitting events occur on each NFT in the collection. In other cases, the splitting events can be on an NFT by NFT basis. For example, one NFT can be split 16 times, whereas another NFT has not yet been split.

In summary, the splitting process creates a hierarchical structure where each tier represents a different level of ownership and data granularity, with increased granularity corresponding to increased fungibility and liquidity. The original NFT is divided into progressively smaller fractions as we move down the tiers. At each tier, the number of fractional NFTs increases, while the ownership stake represented by each fraction decreases.

This hierarchical splitting approach allows for flexible ownership structures and investment opportunities, enabling users to tailor their ownership preferences and trading strategies according to their specific needs. It also facilitates the creation of diverse ownership ecosystems where fractional ownership of NFTs can be traded and exchanged across multiple tiers and levels of granularity.

Before proceeding with the splitting operation, the NFT system prompts users to confirm their actions. This confirmation step helps prevent accidental splitting and ensures that users understand the implications of dividing their NFT.

At block 210, the NFT system prompts user input to transfer, lock, burn, or otherwise transact the NFT. The user then either agrees or refuses to proceed with the transaction. The NFT system receives an indication to split the NFT.

At block 216, the NFT system applies the one or more rules to the NFT to generate a first fractionalized NFT and a second fractionalized NFT. The NFT system applies one or more Smart Contract(s) 182 and/or Rule(s) 108 to split an NFT 110 and/or NFT Data 112.

The User Device 130 initiates a transaction on the Distributed Ledger 180, for example using a wallet private key from the Digital Wallet 722.

The NFT system applies one or more rules to mint, unlock, un-burn, transfer, and/or otherwise transact with one or more NFT(s) (“Lower Tier NFTs”). In an example, the NFT system transfers the Lower Tier NFT(s) to the user.

At block 218, the NFT system initiates recordation onto a blockchain of a removal of ownership by the user of the NFT. This transaction updates the ownership records and creates new tokens representing the fractional shares of the original NFT. One or more new blocks are created in the Distributed Ledger 180 representing one or more of the transaction(s) described.

The NFT system triggers a recordation process to update the ownership records on the blockchain. The user's request to remove ownership of the NFT triggers a transaction on the blockchain and/or the NFT system automatically removes ownership after splitting the NFT.

The blockchain records the details of the ownership change, including the sender (current owner) and recipient (new owner) addresses, the amount of NFTs transferred, and any associated metadata. Unlike traditional change of ownership where ownership is transferred from one party to another, in the case of an NFT split, the ownership is simply removed for the original NFT.

The ownership records stored on the blockchain are updated to reflect the new ownership status of the NFT. This ensures transparency and immutability of ownership information.

At block 220, the NFT system initiates recordation onto the blockchain of ownership by the user of the first fractionalized NFT and the second fractionalized NFT. The NFT system triggers a recordation process to update the blockchain with ownership details of the fractionalized NFTs. This action is initiated after the NFT has been split into fractional shares, and the ownership of these shares needs to be recorded on the blockchain.

The ownership details of the first and second fractionalized NFTs are recorded as transactions on the blockchain. Each transaction contains information about the ownership transfer, including the sender's (current owner) and recipient's (new owner) addresses, the amount of NFT transferred, and any associated metadata. In some cases, the ownership is automatically assigned to the owner of the current NFT or NFT fraction that is being split.

The transaction data includes unique identifiers for each fractionalized NFT, allowing them to be distinguished and tracked independently on the blockchain. The ownership records stored on the blockchain are updated to reflect the new ownership status of the first and second fractionalized NFTs.

The recorded transactions undergo validation and confirmation by the blockchain network through the consensus mechanism. This ensures that the ownership records are accurate and consistent across all nodes within the blockchain network.

The transaction recording the ownership of the first and second fractionalized NFTs results in the creation of new blocks on the blockchain. These blocks contain the transaction data, cryptographic hashes, and other relevant information necessary for maintaining the integrity and security of the blockchain.

The NFT Data may include, but not be limited to, videos, photographs, audio clips, 3D assets, programs, other multimedia files, other files, and/or tokenized interests in non-digital assets and/or property.

In some cases, the NFT system tokenizes an NFT by creating one or more corresponding tokens that represent fractional ownership or specific attributes of the NFT. When an NFT is minted, meaning it is created and added to the blockchain, corresponding tokens can also be minted through the execution of smart contracts. Alternatively, when one or more tokens are minted, an NFT is created.

A smart contract is developed and deployed on the blockchain network. This smart contract defines the rules and functionalities for tokenizing the NFT and creating corresponding tokens. The smart contract specifies the parameters for tokenization, including the number of tokens to be created, the ownership rights associated with each token, and any additional attributes or functionalities of the tokens.

In some cases, the system receives a request to mint a new NFT. This request could come from a user or an automated process and signifies the intent to create a new digital asset on the blockchain.

Upon receiving the request, the system proceeds to mint the NFT. Minting can include creating a unique digital token that represents the NFT. The minting process can also include generating a cryptographic hash or digital signature that uniquely identifies the NFT on the blockchain. Additionally, the NFT metadata, which contains information about the asset such as its title, description, creator, and attributes, is embedded within the NFT.

In addition to minting the NFT itself, the system also mints one or more tokens on the blockchain. These tokens serve as digital representations of ownership or access rights associated with the NFT. The number of tokens minted may depend on various factors, such as the fractional ownership structure or the utility of the NFT.

Once both the NFT and tokens are minted, the system establishes a clear association between them. This association ensures that ownership or access rights represented by the tokens are tied directly to the corresponding NFT. It allows for seamless transfer and management of both the NFT and associated tokens within the blockchain ecosystem.

Alternatively, when the system receives a request to mint one or more tokens, the NFT can be minted. The minting process involves generating unique digital tokens with specific attributes and properties defined by the request. In response to the request to mint tokens, the system simultaneously, subsequently, or prior to, initiates the minting of the associated NFT. Once both the tokens and NFT are minted, the system establishes a clear association between them.

In some cases, the system receives a request to burn the NFT. This request could come from the NFT owner, a rule-based system, or another authorized party who wishes to, directly or indirectly, permanently remove the NFT from circulation. Burning an NFT typically signifies the termination of its existence on the blockchain network.

In response to the received request, the system executes the burning process for the NFT. Burning the NFT involves removing it from circulation within the blockchain ecosystem. Essentially, the unique identifier and metadata associated with the NFT are invalidated or marked as no longer valid, rendering the NFT inaccessible and non-transferable.

Alongside burning the NFT, the NFT system also burns the one or more tokens that were associated with the NFT in response to receiving the request to burn just the NFT. These tokens represent ownership or access rights tied to the NFT. Burning the associated tokens ensures that any ownership or access privileges linked to the NFT are also terminated simultaneously with the NFT itself.

Also alternatively, if a request to burn the one or more tokens are received, then the NFT is also burned. The burning process effectively removes both the NFT and its associated tokens from circulation within the blockchain network. This action prevents any further transactions or transfers involving the NFT or its associated tokens. The assets become unusable and inaccessible on the blockchain, reflecting the irreversible nature of the burning process.

Minting and burning NFTs and tokens together offer several advantages, primarily enhancing liquidity in the NFT market. Traditionally, NFTs were indivisible digital assets sold on the open market, requiring a specific buyer interested in acquiring the entire NFT. However, by tokenizing NFTs and associating them with tokens, fractional ownership becomes possible. This fractionalization enables NFTs to be divided into smaller, more affordable and liquid units, allowing multiple investors to participate in owning a single NFT.

The key advantage lies in the increased accessibility and flexibility for NFT ownership. Instead of requiring a single buyer for the entire NFT, potential investors can purchase fractional tokens representing partial ownership of the NFT. This approach democratizes access to high-value NFT assets, opening up investment opportunities to a wider audience. Additionally, fractional ownership encourages collective ownership and collaborative investment in NFTs, fostering a sense of community and shared participation in digital asset ownership.

Moreover, the ability to tokenize NFTs and associated tokens simplifies the trading and transfer process. Owners can buy, sell, or transfer fractional tokens representing their share of the NFT without the need for direct involvement in the NFT market. This streamlines transactions and enhances market liquidity, as investors can easily trade fractional tokens on secondary markets or specialized platforms dedicated to NFT trading.

Furthermore, tokenization mitigates the risk associated with holding illiquid assets. Owners of fractional tokens have the flexibility to exit their investment by selling their tokens independently of the entire NFT. This increased liquidity reduces the barrier to entry and exit for NFT investments, making them more attractive and accessible to a broader investor base.

In summary, minting and burning NFTs and tokens together unlock new possibilities for fractional ownership and trading in the NFT market. By facilitating fractionalization and tokenization, this approach democratizes access to NFT assets, enhances market liquidity, and provides investors with greater flexibility and control over their digital asset portfolios.

It should be noted that a person skilled in the art should understand that the NFT Splitting Process may further include other steps for implementing execution of the NFT system. In addition, based on specific needs a person skilled in the art should understand that the NFT Splitting Process may further include steps that implement other additional functions. In addition, a person skilled in the art should understand that the NFT Splitting Process may include only steps required for implementing the embodiments, without a need to include all the steps shown in FIG. 2.

Although the examples described herein explain blockchain technology, digital ledger technology, tokens, and/or smart contracts to apply to particular examples, it is appreciated that the features of the tokenization system can be applied to other blockchains, tokens, and/or smart contracts. For example, blockchain technology can be applied to record ownership of fractionalized NFTs, and mint associated tokens, whereas smart contracts can be applied to facilitate fractionalization, change of ownership, and/or the like.

The advent of blockchain technology, tokenization, and/or smart contracts improve trust in the tokenization system using various features rooted in technology. Blockchain technology ensures that once a transaction is recorded on the blockchain, it can't be changed. In the context of the tokenization system, once the owner fractionalizes the NFT, that transaction is recorded permanently. The same goes for each fractionalized NFT that is sold, transferred to another, minted, or burned. This creates a clear, immutable record of who owns the asset, making the system much more trustworthy.

Moreover, every transaction on the blockchain is visible to all network participants. This means that the process of tokenization, as well as each subsequent token purchase, is completely transparent. No one can secretly change the number of tokens or alter the value of the asset, because such a change would be visible to everyone on the network.

The decentralized nature of blockchain also contributes to its trustworthiness. Rather than relying on a single entity (like a bank or government) to verify transactions, blockchain uses a network of nodes (computers). Each node has a copy of the blockchain, and transactions are verified through a consensus process. In essence, multiple parties agree on the validity of transactions, making it virtually impossible for fraudulent activity to occur.

Tokenization of asset ownership, such as in the case of NFTs, provides enhanced security and privacy in several ways. With the blockchain or similar decentralized technology that underlies tokenization, there's no central authority holding all the data. This makes it harder for cybercriminals to exploit a single point of failure.

Moreover, once a transaction is recorded and confirmed on the blockchain, it can't be altered or tampered with. This prevents any fraudulent changes to the ownership records. Every token can be tracked from its inception, offering a clear and indisputable lineage of ownership.

Blockchain uses strong cryptographic algorithms to ensure the data in the blockchain can only be read by those involved in the transaction. This means NFT data can be securely stored and transferred. The tokenization system applies cryptography to tokenize NFTs on a blockchain. In some cases, the tokenization system applies a public-key (asymmetric) cryptography using pairs of keys: public keys (which may be known to others), and private keys (which are known only to the owner).

The generation of such keys depends on cryptographic algorithms based on mathematical problems to produce one-way functions. The owner of the private key can use the key to sign transactions or data, and anyone with the public key can verify the signature. In the context of blockchain tokenization, the ownership of tokens (and therefore the real estate) can be proven by the possession of the private key.

The tokenization system includes a hash function, which given an input, produces a fixed size string of bytes. Every transaction in a blockchain can be hashed and the hash value is stored in the block. Any change in the transaction data would change the hash, which can easily be checked. These hash functions ensure data integrity.

When a token owner wants to transfer their NFTs or tokens (representing ownership of the NFT), the token owner can create a transaction and sign it with their private key. This digital signature proves that the transaction was created by the actual owner and was not tampered with. Anyone can verify the signature with the corresponding public key, but they cannot forge the signature without the private key.

In some cases, the tokenization system encrypts sensitive data using the public key which can only be decrypted using the corresponding private key. This means even if someone else gets hold of this encrypted data, they can't read or understand it without the private key.

These cryptographic features and algorithms of the tokenizing system underpin the security, trust, and immutability aspects of the asset-backed tokens that represent equity in the asset. Such use of keys improves data security by restricting unauthorized use, view, and/or recordation of data onto the tokenization system.

The tokenization system applies smart contracts which are self-executing contracts embedded with the terms of the agreement directly written into code and/or onto the distributed ledger. The smart contracts permit trusted transactions and agreements to be carried out among disparate parties without the need for a central authority, legal system, or external enforcement mechanism.

### Nft Reassembly Sub-System Processor Configurations

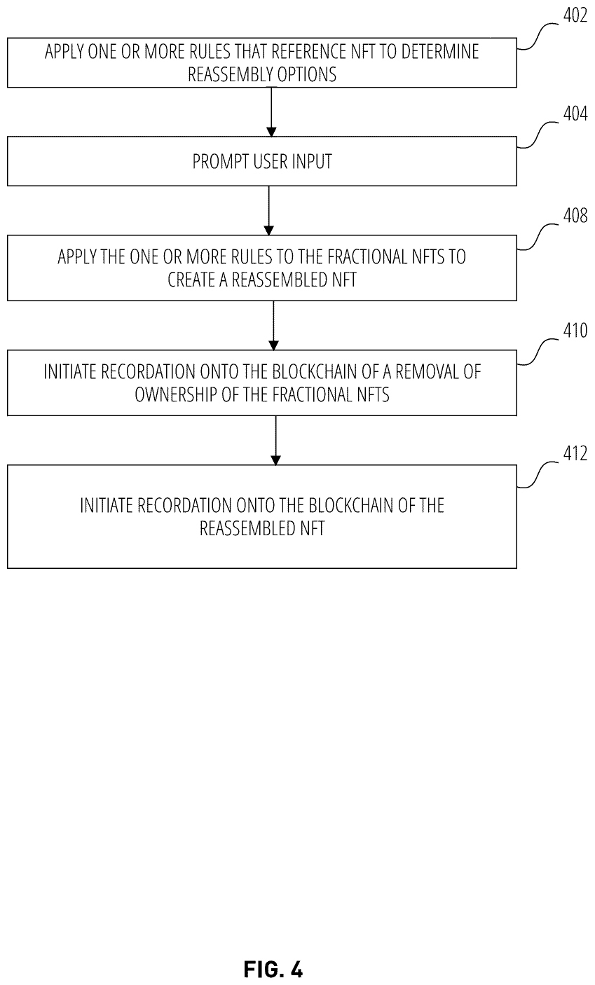

FIG. 4 illustrates an example method for reassembling an NFT, according to some examples. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

At block 402, the NFT system applies one or more rules that reference NFT to determine reassembly options. The reassembly options include options to reassemble the NFTs that were split, such as the features described for FIG. 2 and for FIG. 3. The examples of splitting also apply to examples of reassembly.

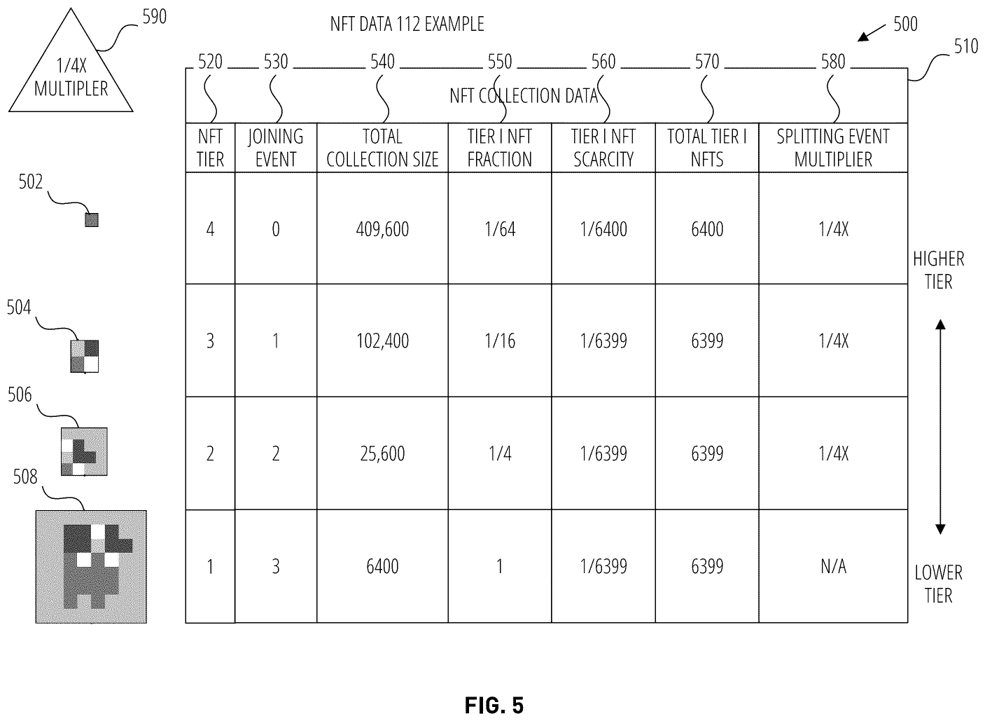

FIG. 5 illustrates an NFT reassembly process, according to some examples. The tier four NFTs 502 include a 1×1 grid multimedia image file in an NFT Collection. The tier four NFTs can be reassembled three times to recreate the original NFTs. For example, 4 tier four NFTs can be combined to create a tier three NFT 504. Four tier three NFTs can be combined to create a tier two NFT 506. Then four tier two NFTs can be combined to create a tier one NFT, which is the original NFT 508.

In the example of FIG. 5, an NFT was divided into 64 tier three NFTs. Four of the tier three NFTs can be combined into a tier two NFT. Once all tier three NFTs are reassembled into tier two NFTs, the user has 16 tier two NFTs. The NFT system can then combine 4 tier two NFTs to create 1 tier one NFT, then combine 4 tier one NFTs to reconstruct the original NFT.

In some cases, the NFT can be made of 8 tier two NFTs and 4 tier one NFTs. The NFT system can combine 4 tier two NFTs to create 1 tier one NFT, and combine the remaining 4 tier two NFTs with the 4 tier one NFTs to reconstruct the original NFT.

In some cases, the NFT can be made of 4 tier two NFTs. The NFT system can combine all 4 tier two NFTs to create I tier one NFT, and then combine 4 tier one NFTs to reconstruct the original NFT.

In some cases, the NFT can be composed of 6 tier two NFTs and 2 tier one NFTs. The NFT system can combine 2 tier two NFTs to create I tier one NFT, and then combine the remaining 4 tier two NFTs with the 2 tier one NFTs to reconstruct the original NFT.

A user using a User Device 130 wishes to reassemble and/or exchange (“join”) an NFT 110 and/or NFT Data 112 in an NFT Collection on a Distributed Ledger 180. The NFT system applies one or more Smart Contract(s) 182 and/or Rules 108 to determine and display joining options available for the NFT 110 and/or NFT Data 112. In an example, the Smart Contracts 182 and/or Rules 108 reference the NFT 110 and no other NFT to determine the joining options available. In an example, the NFT system then prompts and/or requires a user input to transact with the NFT(s) 110 and/or NFT Data 112. The user then either agrees or refuses to proceed with the transaction.

At block 404, the NFT system prompts user input. User input can include instructions on how certain NFT fractions are to be combined, such as only combining certain NFT tiered fractions, or recreating the original NFT.

As the Total Collection Size 540 decreases after successive Joining Events 530, the Tier I NFT Scarcity 560 of the NFT 110 remains the same or decreases. A developer could use the NFT Collection Management Sub-System 106 and/or NFT Collection Management Process 188 to reconfigure variables in the Smart Contract 182 and/or Rules 108 governing or affecting the contraction of the NFT Collection. The variables can include the number of Joining Events 530 and/or the Joining Event Multiplier 580. The NFT Data 112 can include an image multimedia file. In other examples, the NFT Data may include, but not be limited to, videos, photographs, audio clips, 3D assets, programs, other multimedia files, other files, and/or tokenized interests in non-digital assets and/or property.

At block 410, the NFT system initiates recordation onto the blockchain of a removal of ownership of the fractional NFTs. Once the fractional NFTs of a certain tier are combined, the fractional NFTs are no longer in existence. Thus, the NFT system can remove such fractional NFTs out of circulation, such as by removing ownership of the fractional NFTs.

At block 412, the NFT system initiates recordation onto the blockchain of the reassembled NFT. As the newly reassembled NFT is created at a higher tier, the NFT system records such reassembled NFT and its new owner details onto the blockchain.

### Nft Collection Management

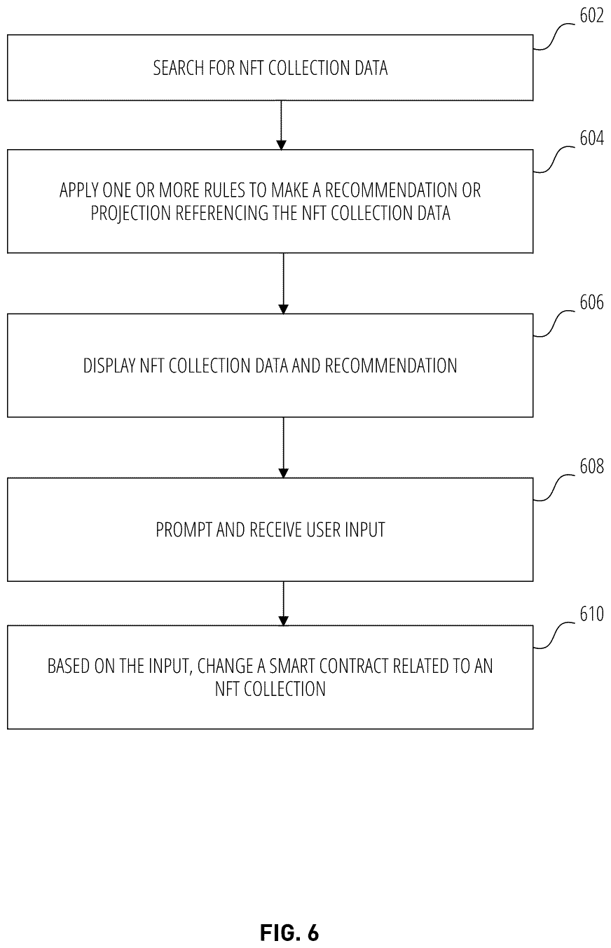

FIG. 6 illustrates an example method for NFT collection management, according to some examples. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

At block 602, the NFT system searches for NFT collection data, which can include information about the NFT collection as a whole and/or individual NFTs in the NFT collection. The NFT collection data can include metadata which can include information about the NFT such as its title, description, creator, creation date, and any relevant tags or keywords. The NFT collection data can include image/visual data for visual NFTs such as digital art or collectibles. The NFT collection data can include audio/video data for NFTs that include audio or video content.

The NFT collection data can include 3D models in the case of 3D digital art or collectibles where the data may include 3D model files along with textures and materials. The NFT collection data can include interactive content where some NFTs may feature interactive or dynamic content, such as games, animations, or AR/VR experiences. The associated data could include code, scripts, or links to interactive elements.

The NFT collection data can include ownership and transaction data where each NFT contains information about its current owner, as well as a record of its transaction history on the blockchain. The NFT collection data can include license or rights information, which may include details about the intellectual property rights associated with the NFT, such as usage rights, resale rights, and any licensing agreements.

The NFT collection data can include provenance information where some NFT collections may include provenance data, documenting the history and authenticity of the asset, including previous owners, exhibitions, and sales. The NFT collection data can include utility or access rights where certain NFTs may grant the owner access to specific services, privileges, or benefits, such as membership in a community, access to exclusive content, or voting rights in governance mechanisms.

A developer using a Developer Device 140 may wish to configure one or more NFT Collection(s) containing NFT(s) 110 and/or NFT Data 112 on a Distributed Ledger 180 in order to manage, expand, and/or contract the NFT Collection and/or manage the scarcity of NFT(s) 110 and/or NFT Data 112 in the NFT Collection. The Developer Device connects to the Distributed Ledger 180 through a communications Network 190 and the Developer Device 140 receives NFT Collection data 310 or 510, including but not limited to: NFT Tier 320 or 520, number of Splitting Events 330 or 530, Total Collection Size 340 or 540, Tier I NFT Fraction 350 or 550 (fraction of a Tier I NFT in the NFT Collection represented by the NFT Split and/or NFT Data Splits), Tier I NFT Scarcity 360 or 560, Total Tier I NFTs 370 or 570, and Splitting Event Multiplier 380 or 580. In an example, the method displays the referred NFT Collection data 310 or 510 to the developer.

At block 604, the NFT system applies at least one rule to the NFT Collection data to make a recommendation and/or projection about the expansion, contraction, and/or management of the NFT Collection and/or management of the scarcity of NFT(s) 110 and/or NFT Data 112 in the NFT Collection.

The NFT system may receive one or more input(s) from the developer to make the recommendation and/or projection. For example, the NFT system may prompt and/or require one or more input(s) from the developer to manage the expansion and/or contraction of the NFT Collection and/or NFT tiers 320 or 520 in the NFT Collection, and/or manage the scarcity of NFT(s) 110 and/or NFT Data 112 in the NFT Collection and/or NFT Collection tiers 320 or 520.

The NFT system may receive one or more input(s) from the developer and/or other input source to manage the expansion and/or contraction of the NFT Collection and/or NFT tiers 320 or 520 in the NFT Collection, and/or manage the scarcity of NFT(s) 110 and/or NFT Data 112 in the NFT Collection. For example, the developer and/or other input may change one or more Smart Contracts 182 and/or Rules 108 in the Tokenization Platform 100, Distributed Ledger 180, User Devices 130, Developer Devices 140, Node Devices 150. For example, the developer and/or other input could configure an NFT Collection by configuring variables in the Smart Contracts 182 and/or Rules 108 governing or affecting the expansion of the NFT Collection. In an example, the variables include, but are not limited to, the number of Splitting Events 330 or 530 and/or the Splitting Event Multiplier 380 or 580.

At block 606, the NFT system displays the NFT collection data to the user. Once the user has the NFT data and recommendations, the user can provide input on how the user wants the NFT collection to change at block 608.

At block 610, based on the user input, the NFT system changes a smart contract related to an NFT collection. For example, original NFTs in the NFT collection can be split into tier one NFT fractions.

In some embodiments, a method for managing NFT Collection size while managing NFT scarcity, fungibility, and liquidity in a decentralized network may be provided. The method may include an NFT Splitting Process and/or an NFT Reassembly and/or Exchange Process and/or an NFT Collection Management Process, as described herein. The method may be performed by a smart contract and/or rules configured to be stored on a distributed ledger. The smart contracts and/or rules may be configured to receive one or more NFTs and/or NFT Data. In some embodiments, the NFTs may represent ownership of a physical asset. In response to receiving the NFTs, the smart contracts and/or rules may be configured to mint, transfer, lock, unlock, burn, un-burn, split, reassemble, join, exchange, and/or otherwise transact with NFTs, NFT Data and/or other NFTs and/or NFT Data.

In some embodiments, a method for managing NFT Collection size includes successive, tiered fractionalization that includes transferring, minting, locking, burning, and/or otherwise transacting with NFT(s) and/or NFT Data, creating scarcity, fungibility, or liquidity for NFTs and/or NFT Data in an NFT Collection.

In some embodiments of the method the number of tiers, successive splitting or joining events, and/or multipliers applied are determined by one or more rule(s) stored in memory, on a network, one or more user or developer devices, nodes, and/or on a distributed ledger. In some embodiments the number of tiers, successive splitting or joining events, and/or multipliers applied cannot be changed. In some embodiments the number of tiers, successive splitting or joining events, and/or multipliers applied can be changed by an input. The method may be configured to receive inputs from users, developers, systems, and/or programs.

In some embodiments, the method for managing NFT Collection size includes successive, tiered fractionalization that includes transferring, minting, locking, burning, and/or otherwise transacting with an NFT on a distributed ledger and also successively splitting one or more multi-media or other files associated with an NFT, thereby creating scarcity for some tiers of the NFT Collections while managing the total number of NFTs in and/or gating an NFT-gated network and/or the total number of NFTs in a collection. In some embodiments the method includes multimedia or other files that are stored in memory, on a network, one or more user or developer devices, nodes, and/or on a distributed ledger. In some embodiments, the method includes splitting multimedia or other files according to at least one splitting rule that may or may not be changed by an input. In some embodiments, the method includes receiving inputs from users, developers, systems, or programs. In some embodiments, the splitting rule(s) cannot be changed.

In some embodiments, the method includes gating access based on ownership of NFTs or numbers of NFTs within fractionalized tiers of an NFT Collections. In some embodiments, the method includes receiving inputs from users, developers, systems, and/or programs.

In some embodiments, the method includes reassembling and/or exchanging NFTs in an NFT Collection for other NFTs in an NFT Collection based on at least one rule. In some embodiments, the method includes reassembling and/or exchanging one or more lower tier NFT(s) in an NFT Collection for one or more higher tier NFT(s) in an NFT Collection. In some embodiments, the method includes joining one or more multimedia and/or other files associated with NFTs and/or referenced in NFT metadata of NFTs in an NFT Collection into one or more multimedia and/or other files associated with and/or referenced in the metadata of one or more NFTs in an NFT Collection. In some embodiments, the method includes joining one or more multimedia and/or other files associated with NFTs and/or referenced in NFT metadata of lower tier NFTs in an NFT Collection into one or more multimedia and/or other files associated with and or referenced in the metadata of one or more higher tier NFTs in an NFT Collection. In some embodiments, the method includes changing the one or more rule(s) affecting the reassembly, joining, and/or exchange of NFTs and/or multimedia and/or other files by an input. The system may be configured to receive inputs from users, developers, systems, and/or programs.

### Affiliate Features

The interaction system can be used to enable and empower the creation of scalable, multi-level affiliate marketing networks with NFTs. The interaction system allows for the design, creation, and management of NFT Collections designed for this purpose.

The interaction system can also be used to set and control affiliate marketing variables for the NFT Collection, such as:
1) linking the collection to “affiliate stores” (e-commerce or IRL sites offering (or launching) digital or IRL products, services, media etc. for pre-sale, sale, licensing, subscription, redemption, or consumption, etc.),
2) setting discounts on affiliate stores for affiliate marketing referrals (thereby incentivizing affiliate store marketing and sales),
3) setting affiliate marketing commissions (as percentages or fixed fees or performing a calculation) for referrals by different Tiers of NFTs in the NFT Collection (thereby incentivizing affiliates to market for affiliate stores), or
4) setting “splitting commissions” (as percentages or fixed fees or performing a calculation) for affiliates that split higher Tier NFTs into lower Tier NFTs (thereby incentivizing affiliate marketing networks to scale). Affiliate marketing variables may be uniform across an entire affiliate store, or be set differently for particular items in an affiliate store.

Once variables are initially set for an NFT collection, the interaction system allows for minting/creation of collection NFTs, starting at any Tier.

Then, ownership of NFTs can be transferred/assigned to new owners who become “affiliates”. The NFT can be transferred to the new owner/affiliate for free, sold, given as a reward for certain behavior, awarded in a raffle, or transferred in some other way. The affiliate may not even know that they own an NFT or are interacting with a blockchain. The interaction system may conceal some or all on-chain or NFT activity from affiliates.

Affiliates may use the interaction system to transact with their NFTs to achieve certain effects. They may split their NFTs or fuse them with other NFTs (reassembly). For example, Tier I NFT's could be issued first and then be fractionalized into a number of Tier II NFTs. Alternatively. Tier II NFT's could be issued first and reassembled into Tier I NFTs or split into Tier III NFTs.

The interaction system allows NFTs of any Tier to be linked to unique affiliate identifiers so that affiliate stores can know when a customer is referred by an affiliate. When such a referral is detected, the interaction system can apply affiliate variables customizing the customer experience, for example displaying or applying discounts for the customer. Then, upon a purchase by the customer, the interaction system determines and sends any applicable affiliate marketing commissions or splitting commissions directly to the relevant affiliate(s).

Splitting or reassembling NFTs into different Tiers can affect the applicable affiliate marketing variables such as linked affiliate stores, discounts, commissions, and/or splitting commissions. For example a Tier I NFT may have access to a different affiliate store than a Tier II NFT of the same collection. Similarly, a Tier I NFT may offer different discounts to potential buyers than a Tier II NFT. A Tier I NFT may also have a higher affiliate commission than a Tier II NFT. Splitters of Tier I NFTs into subsets of Tier II NFTs may receive splitting commissions from sales generated by the subset of Tier II NFTs. In some examples, the difference between the Tier I and Tier II commissions can be equal to the splitting commission. Through splitting commissions, affiliates who split NFTs may receive passive income from the affiliate marketing of resulting subset NFTs. The interaction system can allow for splitters to own and transfer/assign/sell ownership of their ability to receive splitting commissions to others.

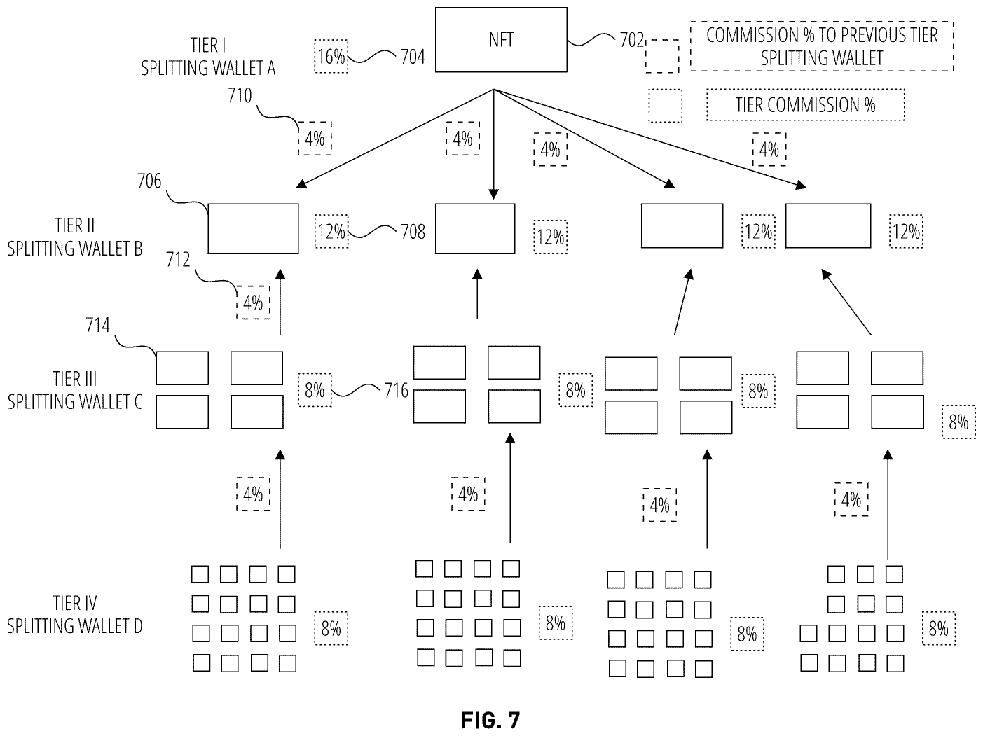

FIG. 7 illustrates an architecture for affiliate features using NFT fractionalization, according to some examples. The original NFT and its subsequent tiers generate commissions in an affiliate marketing network, including how these commissions are divided upon splitting.

The original Tier I NFT 702 is the original NFT in the collection. The original NFT has a commission percentage 704 of 16%. This means that any sales or transactions involving products or services linked to this NFT will generate a commission of 16% of the sale price. This commission is provided to the owner of the original NFT.

The interaction system splits original NFT 702 into four Tier II NFTs 706. Each of these Tier II NFTs inherits a smaller commission percentage 708 of 12%. When the original NFT is split into Tier II fractions, the 16% commission is divided such that 4% 710 of the commission goes to the wallet that performed the splitting. Each of the four Tier II NFTs then has a 12% commission.

The interaction system enables further splitting into Tier III Fractions 714. Each of the Tier II NFTs can be further split into smaller Tier III NFTs. Each of these Tier III NFTs inherits a smaller commission percentage 714 of 8%.

When a Tier II NFT is split into Tier III fractions, the 12% commission from Tier II is divided such that 4% 712 of the commission goes to the wallet 712 that performed the splitting. Each of the resulting Tier III NFTs then has an 8% commission 716. This structure incentivizes splitting NFTs and expanding the affiliate network, as each tier's owner earns a portion of the commissions from the tiers they create.

### Examples

Example 1 is a method comprising: displaying an non-fungible token (NFT); determining ownership of the NFT by a first user; identifying NFT splitting options based on one or more rules for the NFT; displaying NFT splitting options to the first user; receiving input from the first user to perform a particular splitting operation on the NFT; generating a hash indicative of a transaction for the splitting operation; and executing a first smart contract, the execution of the first smart contract causing operations including: applying the one or more rules to the NFT to generate at least a first fractionalized NFT and a second fractionalized NFT; initiating recordation onto a blockchain of a removal of ownership by the first user of the NFT; and initiating recordation onto the blockchain of the generated hash and ownership by the first user of the first fractionalized NFT and the second fractionalized NFT.

In Example 2, the subject matter of Example 1 includes, wherein the NFT splitting options comprise splitting the NFT into tier one NFT fractions based on a first splitting event multiplier, wherein the tier one NFT fractions include the first fractionalized NFT and the second fractionalized NFT.

In Example 3, the subject matter of Example 2 includes, wherein: the NFT comprises a number of pixels, the number of pixels for each of the tier one NFT fractions are the number of pixels for the NFT divided by the first splitting event multiplier.

In Example 4, the subject matter of Examples 2-3 includes, splitting the first fractionalized NFT into tier two NFT fractions based on a second splitting event multiplier, a number of pixels for each of the tier two NFT fractions is a number of pixels of the NFT divided by the first splitting event multiplier and the second splitting event multiplier.

In Example 5, the subject matter of Examples 2-4 includes, wherein the recordation of ownership onto the blockchain includes a partial ownership of the NFT for each of the tier one NFT fractions based on the first splitting event multiplier.

In Example 6, the subject matter of Examples 2-5 includes, wherein the input received from the user includes a number of tier fractions and the first splitting event multiplier, the method further comprises continually splitting the NFT fractions based on the number of tier fractions.

In Example 7, the subject matter of Examples 2-6 includes, receiving a request to change ownership of the first fractionalized NFT to a second user; initiating recordation onto the blockchain of a change in ownership from the first user to the second user for the first fractionalized NFT, wherein the first user remains the owner of the second fractionalized NFT on the blockchain.

In Example 8, the subject matter of Examples 1-7 includes, receiving a request to mint the NFT; in response to receiving the request to mint the NFT: minting the NFT that includes the NFT metadata and a unique identifier to identify the NFT on the blockchain; minting one or more tokens of the blockchain; and associating the one or more tokens with the minted NFT.

In Example 9, the subject matter of Example 8 includes, receiving a request to burn the NFT; in response to receiving the request to burn the NFT: burning the NFT by removing the NFT from circulation; and burning the one or more tokens associated with the NFT from circulation.

In Example 10, the subject matter of Examples 8-9 includes, receiving a request to burn the one or more tokens; in response to receiving the request to burn the NFT: burning the NFT by removing the NFT from circulation; and burning the one or more tokens associated with the NFT from circulation.

In Example 11, the subject matter of Examples 8-10 includes, receiving a request to reassemble the first fractionalized NFT and the second fractionalized NFT; and executing a second smart contract, the execution of the second smart contract causing operations including: reassembling the NFT by combining the first fractionalized NFT and the second fractionalized NFT; burning tokens associated with the first fractionalized NFT and the second fractionalized NFT; minting new tokens and associating the new tokens to the reassembled NFT; initiating recordation onto a blockchain of a removal of ownership of the first fractionalized NFT and the second fractionalized NFT; and initiating recordation onto the blockchain of ownership of the NFT.

In Example 12, the subject matter of Examples 1-11 includes, receiving a request to mint one or more tokens of the blockchain; in response to receiving the request to mint the NFT: minting the NFT that includes the NFT metadata and a unique identifier to identify the NFT on the blockchain; minting one or more tokens of the blockchain; and associating the one or more tokens with the minted NFT.

In Example 13, the subject matter of Examples 1-12 includes, receiving a request to reassemble the first fractionalized NFT and the second fractionalized NFT; and executing a second smart contract, the execution of the second smart contract causing operations including: reassembling the NFT by combining the first fractionalized NFT and the second fractionalized NFT; initiating recordation onto a blockchain of a removal of ownership of the first fractionalized NFT and the second fractionalized NFT; and initiating recordation onto the blockchain of ownership of the NFT.

In Example 14, the subject matter of Examples 11-13 includes, wherein the removal of ownership is recorded regardless of the current owners of the first fractionalized NFT and the second fractionalized NFT.

Example 15 is a system comprising: at least one processor; and at least one memory component storing instructions that, when executed by the at least one processor, cause the at least one processor to perform operations comprising: displaying an non-fungible token (NFT); determining ownership of the NFT by a first user; identifying NFT splitting options based on one or more rules for the NFT; displaying NFT splitting options to the first user; receiving input from the first user to perform a particular splitting operation on the NFT; generating a hash indicative of a transaction for the splitting operation; and executing a first smart contract, the execution of the first smart contract causing operations including: applying the one or more rules to the NFT to generate at least a first fractionalized NFT and a second fractionalized NFT; initiating recordation onto a blockchain of a removal of ownership by the first user of the NFT; and initiating recordation onto the blockchain of the generated hash and ownership by the first user of the first fractionalized NFT and the second fractionalized NFT.

In Example 15, the subject matter of Example 15 includes, wherein the NFT splitting options comprise splitting the NFT into tier one NFT fractions based on a first splitting event multiplier, wherein the tier one NFT fractions include the first fractionalized NFT and the second fractionalized NFT.

In Example 16, the subject matter of Example 16 includes, wherein: the NFT comprises a number of pixels, the number of pixels for each of the tier one NFT fractions are the number of pixels for the NFT divided by the first splitting event multiplier.

In Example 18, the subject matter of Examples 16-16 includes, splitting the first fractionalized NFT into tier two NFT fractions based on a second splitting event multiplier, a number of pixels for each of the tier two NFT fractions is a number of pixels of the NFT divided by the first splitting event multiplier and the second splitting event multiplier.

Example 19 is a non-transitory computer-readable storage medium storing instructions that, when executed by at least one processor, cause the at least one processor to perform operations comprising: displaying an non-fungible token (NFT); determining ownership of the NFT by a first user; identifying NFT splitting options based on one or more rules for the NFT; displaying NFT splitting options to the first user; receiving input from the first user to perform a particular splitting operation on the NFT; generating a hash indicative of a transaction for the splitting operation; and executing a first smart contract, the execution of the first smart contract causing operations including: applying the one or more rules to the NFT to generate at least a first fractionalized NFT and a second fractionalized NFT; initiating recordation onto a blockchain of a removal of ownership by the first user of the NFT; and initiating recordation onto the blockchain of the generated hash and ownership by the first user of the first fractionalized NFT and the second fractionalized NFT.

Example 20 is at least one machine-readable medium including instructions that, when executed by processing circuitry, cause the processing circuitry to perform operations to implement of any of Examples 1-19.

Example 21 is an apparatus comprising means to implement of any of Examples 1-19.

Example 22 is a system to implement of any of Examples 1-19.

Example 23 is a method to implement of any of Examples 1-19.

### CONCLUSION

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

In the example embodiments, it should be understood that the NFT system, the NFT system, and the various devices may be implemented in other manners. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments. In addition, functional units in the example embodiments may be integrated into one processing unit, or each of the units may exist alone physically, or two or more units may be integrated into one unit.

When the functions are implemented in the form of a software functional unit and sold or used as an independent product, the functions may be stored in a computer readable storage medium. Based on such an understanding, the technical solutions of example embodiments may be implemented in the form of a software product. The software product is stored in a storage medium, and includes several instructions for instructing a computing device to perform all or some of the steps or processes of the methods described in the example embodiments. The foregoing storage medium includes any medium that can store program code, such as a universal serial bus flash drive, removable hard disk, read only memory, random access memory, magnetic disc, and/or an optical disc.

In the described methods or block diagrams, boxes may represent events, steps, functions, processes, modules, messages, and/or state based operations, etc. While some of the example embodiments have been described as occurring in a particular order, some of the steps or processes may be performed in a different order provided that the result of the changed order of any given step will not prevent or impair the occurrence of subsequent steps. Furthermore, some of the messages or steps described may be removed or combined in other embodiments, and some of the messages or steps describe herein may be separated into a number of sub-messages or sub-steps in other embodiments. Even further, some or all of the steps may be repeated, as necessary. Elements described as methods, steps, or processes similarly apply to systems, subsystems, or subcomponents, and vice versa. Reference to such a word as sending or receiving could be interchanged depending on the perspective of the particulars device. The described embodiments are considered to be illustrative and not restrictive. Example embodiments described as methods would similarly apply to systems, subsystems, or devices, and vice versa.

The various example embodiments are merely examples and are in no way meant to limit the scope of this disclosure. Variations of the innovations describe herein will be apparent to persons of ordinary skill in the art, such variations being within the intended scope. In particular features from one or more of the example embodiments may be selected to create alternative embodiments comprised of a sub-combination of features which may not be explicitly described. In addition, features from one or more of the described example embodiments may be selected and combined to create alternative example embodiments comprised of a combination of features which may not be explicitly described. Features suitable for such combinations and sub-combinations would be readily apparent a person skilled in the art. The subject matter describe herein intends to cover all suitable changes in technology.

What is claimed is:

1. A method comprising:
displaying a non-fungible token (NFT);
determining ownership of the NFT by a first user;
identifying NFT splitting options based on one or more rules for the NFT;
displaying NFT splitting options to the first user;
receiving input from the first user to perform a particular splitting operation on the NFT;
and
executing a first smart contract, the execution of the first smart contract causing operations including:
applying the one or more rules to the NFT to generate at least a first fractionalized NFT and a second fractionalized NFT;
initiating recordation onto a blockchain of a removal of ownership by the first user of the NFT; and
initiating recordation onto the blockchain of the generated hash and ownership by the first user of the first fractionalized NFT and the second fractionalized NFT.

2. The method of claim 1, wherein the NFT splitting options comprise splitting the NFT into tier one NFT fractions based on a first splitting event multiplier, wherein the tier one NFT fractions include the first fractionalized NFT and the second fractionalized NFT.

3. The method of claim 2, wherein:
the NFT comprises a number of pixels,
the number of pixels for each of the tier one NFT fractions are the number of pixels for the NFT divided by the first splitting event multiplier.

4. The method of claim 2, further comprising splitting the first fractionalized NFT into tier two NFT fractions based on a second splitting event multiplier, a number of pixels for each of the tier two NFT fractions is a number of pixels of the NFT divided by the first splitting event multiplier and the second splitting event multiplier.

5. The method of claim 2, wherein the recordation of ownership onto the blockchain includes a partial ownership of the NFT for each of the tier one NFT fractions based on the first splitting event multiplier.

6. The method of claim 2, wherein the input received from the user includes a number of tier fractions and the first splitting event multiplier, the method further comprises continually splitting the NFT fractions based on the number of tier fractions.

7. The method of claim 2, further comprising:
receiving a request to change ownership of the first fractionalized NFT to a second user;
initiating recordation onto the blockchain of a change in ownership from the first user to the second user for the first fractionalized NFT, wherein the first user remains the owner of the second fractionalized NFT on the blockchain.

8. The method of claim 1, further comprising:
receiving a request to mint the NFT;
in response to receiving the request to mint the NFT:
minting the NFT that includes the NFT metadata and a unique identifier to identify the NFT on the blockchain;
minting one or more tokens of the blockchain; and
associating the one or more tokens with the minted NFT.

9. The method of claim 8, further comprising:
receiving a request to burn the NFT;
in response to receiving the request to burn the NFT:
burning the NFT by removing the NFT from circulation; and
burning the one or more tokens associated with the NFT from circulation.

10. The method of claim 8, further comprising:
receiving a request to burn the one or more tokens;
in response to receiving the request to burn the NFT:
burning the NFT by removing the NFT from circulation; and
burning the one or more tokens associated with the NFT from circulation.

11. The method of claim 8, further comprising:
receiving a request to reassemble the first fractionalized NFT and the second fractionalized NFT; and
executing a second smart contract, the execution of the second smart contract causing operations including:
reassembling the NFT by combining the first fractionalized NFT and the second fractionalized NFT;
burning tokens associated with the first fractionalized NFT and the second fractionalized NFT;
minting new tokens and associating the new tokens to the reassembled NFT;
initiating recordation onto a blockchain of a removal of ownership of the first fractionalized NFT and the second fractionalized NFT; and
initiating recordation onto the blockchain of ownership of the NFT.

12. The method of claim 1, further comprising:
receiving a request to mint one or more tokens of the blockchain;
in response to receiving the request to mint the NFT:
minting the NFT that includes the NFT metadata and a unique identifier to identify the NFT on the blockchain;
minting one or more tokens of the blockchain; and
associating the one or more tokens with the minted NFT.

13. The method of claim 1, further comprising:
receiving a request to reassemble the first fractionalized NFT and the second fractionalized NFT; and
executing a second smart contract, the execution of the second smart contract causing operations including:
reassembling the NFT by combining the first fractionalized NFT and the second fractionalized NFT;
initiating recordation onto a blockchain of a removal of ownership of the first fractionalized NFT and the second fractionalized NFT; and
initiating recordation onto the blockchain of ownership of the NFT.

14. The method of claim 13, wherein the removal of ownership is recorded regardless of the current owners of the first fractionalized NFT and the second fractionalized NFT.

15. A system comprising:
at least one processor; and
at least one memory component storing instructions that, when executed by the at least one processor, cause the at least one processor to perform operations comprising:
displaying an non-fungible token (NFT);
determining ownership of the NFT by a first user;
identifying NFT splitting options based on one or more rules for the NFT;
displaying NFT splitting options to the first user;
receiving input from the first user to perform a particular splitting operation on the NFT;
and
executing a first smart contract, the execution of the first smart contract causing operations including:
applying the one or more rules to the NFT to generate at least a first fractionalized NFT and a second fractionalized NFT;
initiating recordation onto a blockchain of a removal of ownership by the first user of the NFT; and
initiating recordation onto the blockchain of the ownership by the first user of the first fractionalized NFT and the second fractionalized NFT.

16. The system of claim 15, wherein the NFT splitting options comprise splitting the NFT into tier one NFT fractions based on a first splitting event multiplier, wherein the tier one NFT fractions include the first fractionalized NFT and the second fractionalized NFT.

17. The system of claim 16, wherein:
the NFT comprises a number of pixels,
the number of pixels for each of the tier one NFT fractions are the number of pixels for the NFT divided by the first splitting event multiplier.

18. The system of claim 16, the operations further comprising splitting the first fractionalized NFT into tier two NFT fractions based on a second splitting event multiplier, a number of pixels for each of the tier two NFT fractions is a number of pixels of the NFT divided by the first splitting event multiplier and the second splitting event multiplier.

19. The system of claim 16, the operations further comprising:
receiving a request to mint one or more tokens of the blockchain;
in response to receiving the request to mint the NFT:
minting the NFT that includes the NFT metadata and a unique identifier to identify the NFT on the blockchain;
minting one or more tokens of the blockchain; and
associating the one or more tokens with the minted NFT.

20. A non-transitory computer-readable storage medium storing instructions that, when executed by at least one processor, cause the at least one processor to perform operations comprising:
displaying an non-fungible token (NFT);
determining ownership of the NFT by a first user;
identifying NFT splitting options based on one or more rules for the NFT;
displaying NFT splitting options to the first user;
receiving input from the first user to perform a particular splitting operation on the NFT;
and
executing a first smart contract, the execution of the first smart contract causing operations including:
applying the one or more rules to the NFT to generate at least a first fractionalized NFT and a second fractionalized NFT;
initiating recordation onto a blockchain of a removal of ownership by the first user of the NFT; and
initiating recordation onto the blockchain of the ownership by the first user of the first fractionalized NFT and the second fractionalized NFT.
